(19) United States
(12) Patent Application Publication
(10) Pub. No.: US 2026/0036660 A1
(43) Pub. Date: Feb. 5, 2026

(54) APPARATUSES AND METHODS FOR USER GUIDANCE

(71) Applicant: James N. RILEY, West Chester, PA (US)

(72) Inventor: James N. RILEY, West Chester, PA (US)

(21) Appl. No.: 19/285,635

(22) Filed: Jul. 30, 2025

Related U.S. Application Data
(60) Provisional application No. 63/677,201, filed on Jul. 30, 2024.

(51) Int. Cl. G01S 3/46; G01S 3/04; G06F 3/01

(52) U.S. Cl. CPC G01S 3/46; G01S 3/046; G06F 3/014

(57) ABSTRACT

Systems and methods are described to determine a direction and distance from a participant unit to a guide unit as both the participant unit and guide units move. The participant unit determines the direction and distance and based thereon generates an output to various sensory elements worn or used by the participant to indicate those values dynamically to the participant.

### CROSS-REFERENCE TO RELATED APPLICATIONS

This application claims priority to and the benefit of U.S. Provisional Patent Application 63/677,201, titled Apparatuses and Methods for Blind Athlete Guidance and filed on Jul. 30, 2024, the entirety of which is incorporated by reference herein.

### TECHNICAL FIELD

The disclosures herein generally pertain to adaptive equipment, and more particularly relate to providing feedback according to different senses to guide people to guide their movements, particularly people who may have deficits as to one or more senses.

### BACKGROUND

Traditional methods of guidance for visually impaired or blind participants in activities who wish to move independently, such as blind athletes that may be participating in outdoor sports, may include talk, tandem, or tether. A visually impaired participant's guide's primary responsibility may be the safety of the visually impaired participant. This may require the guide to be attentive to the route and/or alert the visually impaired individual for hazards. The guide may further be required to divert the visually impaired individual from danger or departing the route. An additional responsibility may be to offer comfort and/or a therapeutic effect that an outdoor activity may provide based on trust that may be built between the participant and the guide through communication.

### SUMMARY

The disclosures herein accomplish the objectives and resolve the problems set forth above by reducing dependence on audible navigation and physical connections as well as allowing more appreciation of nature and ambient environment sounds. Inventions herein utilize Direction Finding and tactile technologies to augment “follow-me” guidance of blind athletes in adaptive outdoor sports.

In embodiments, a two-unit system is provided, with one worn or carried by the guide and one worn by the blind athlete. The first unit is configured to be worn or carried by a guide and is further configured to emit a guide signal. The second unit is configured to be worn by a participant (e.g., the blind athlete). The second unit is configured to receive the guide signal from the first unit and interpret the guide signal to determine a direction and a distance from the second unit to the first unit. The second unit is operatively coupled with or incorporated into a wearable apparatus including a group of haptic output components. The haptic output components are arranged in a manner such that they are distributed around the participant when worn. The second unit is configured to generate, based on the direction and the distance, an output signal. The second unit is further configured to send the output signal to the group of haptic components. One haptic component of the group of haptic components is configured to actuate in response to the signal based on the direction. Actuation of the one of the group of haptic components configured to represent the distance.

In another example, a method is provided for providing guidance for a vision impaired individual. The method may include: sending, from a first device, a request for a ranging signal to a second device; sending the ranging signal from the second device to the first device; receiving the ranging signal to the second device and providing a notification of a range, from the second device to the first device, to the user of the first device; sending a signal corresponding to an angle of arrival from the second device to the first device; and in response to receiving the signal corresponding to the angle of arrival, providing a notification, corresponding to a direction from the first device to the second device, to the user of the first device. This example may further include: sending a signal corresponding to a respective command to the first device from a third device; receiving the signal corresponding to the respective command to the second device; in response to receiving the signal; in accordance with a determination that the respective command is a first command, providing a start command, via the first device, to the user of the first device; and in accordance with a determination that the respective command is a second command, providing a stop command, via the first device, to the user of the first device.

In an alternate aspect, the method for providing guidance to the vision impaired individual may include: sending, to the first device from a third device, a signal corresponding to a respective command; receiving, to the first device, the signal corresponding to a respective command from the third device; in response to receiving the signal corresponding to the respective command from the third device and in accordance with a determination that the respective command is a first command, providing a start command the a user of the first device; and in response to receiving the signal corresponding to the respective command from the third device and in accordance with a determination that the respective command is a second command, providing a stop command to the user of the first device.

In another example, a method for providing enhancing the awareness of a state of a vision impaired individual wearing a guidance vest system may be provided. The method may include: displaying, at a first device, a user interface including an indication of a respective distance from a second device to a third device, an indication of a respective direction from the second device to the third device, and an indication of a respective state of motion of the second device; while displaying the user interface, receiving from the second device a signal corresponding to the respective distance from the second device to the third device; in response to receiving the signal and in accordance with a determination that the respective distance is a first distance, displaying the user interface wherein the indication of the respective distance from the second device to the third device is an indication of the first distance from the second device to the third device; in response to receiving the signal and in accordance with a determination that the respective distance is a second distance different from the first distance, displaying the user interface, wherein the indication of the respective distance from the second device to the third device is an indication of the second distance from the second device to the third device; receiving from the second device a signal corresponding to the respective direction from the second device to the third device; in response to receiving the signal and in accordance with a determination that the respective direction is a first direction, displaying the user interface wherein the indication of the respective direction from the second device to the third device is an indication of the first direction from the second device to the third device; in response to receiving the signal and in accordance with a determination that the respective direction is a second direction different from the first direction, displaying the user interface, wherein the indication of the respective direction from the second device to the third device is an indication of the second direction from the second device to the third device; receiving, from the second device, a signal corresponding to the respective state of motion of the second device; in response to receiving the signal and in accordance with a determination that the respective state of motion is a first state of motion, displaying the user interface, wherein the indication of the respective state of motion is an indication of the first state of motion; and in response to the signal and in accordance with a determination that the respective state of motion is a second state of motion, displaying the user interface, wherein the indication of the respective state of motion is an indication of the second state of motion.

In an alternate example, the method for providing enhancing the awareness of a state of a vision impaired individual wearing a guidance vest system may include: while displaying the user interface, displaying, via the one or more display generation components, a first button and a second button; detecting an input corresponding to a respective button; in response to detecting the input and in accordance with a determination that the respective command is a first command, providing a start command to a user of the first device; and in response to detecting the input and in accordance a determination that the respective command is a second command, providing a stop command, to the user of the first device.

While this Summary provides an overview of some aspects of inventions described, various further, alternative, and complementary aspects will be appreciated by those of skill in the art on review of the disclosures herein, and as such, this Summary should not be deemed to in any way limit the scope or spirit of this application or any application claiming priority to this application.

### BRIEF DESCRIPTION OF THE DRAWINGS

FIG. 1 is an example guide beacon in accordance with an example of the present disclosure.

FIG. 2A is an example vest system in accordance with an example of the present disclosure.

FIG. 2B is an example vest system in accordance with an example of the present disclosure.

FIG. 2C is an example of a belt of a vest system in accordance with an example of the present disclosure.

FIG. 3A is an example diagram of an example vest guidance unit in accordance with an example of the present disclosure.

FIG. 3B is an example diagram of an example vest guidance unit in accordance with an example of the present disclosure.

FIG. 3C is an example diagram of an example vest guidance unit in accordance with an example of the present disclosure.

FIG. 3D is an example diagram of an example vest guidance unit in accordance with an example of the present disclosure.

FIG. 3E is an example diagram of an example vest guidance unit in accordance with an example of the present disclosure.

FIG. 3F is an example diagram of an example vest guidance unit in accordance with an example of the present disclosure.

FIG. 4 is an example block diagram of an example system in accordance with an example of the present disclosure.

FIG. 5 is an example block diagram of an example hardware/software architecture of a communication device in accordance with an example of the present disclosure.

FIG. 6 is an example user interface for an application of computer program product that may enable a guide to monitor a vest guidance unit of a vision impaired individual in accordance with an example of the present disclosure.

FIG. 7 illustrates an example method for providing distance guidance to a vision impaired individual in accordance with an example of the present disclosure.

FIG. 8 illustrates an example method for providing direction guidance to a vision impaired individual in accordance with an example of the present disclosure.

FIG. 9 illustrates an example method for providing one or more directions to a vision impaired individual using a guide vest in accordance with an example of the present disclosure.

FIG. 10A illustrates an example process for transmitting a ranging signal to a vest system of an impaired individual using a guide beacon in accordance with an example of the present disclosure.

FIG. 10B illustrates an example process for transmitting a direction-finding signal to a vest system of an impaired individual using a guide beacon in accordance with an example of the present disclosure.

FIG. 11A illustrates an example process for initializing a vest guidance unit in accordance with an example of the present disclosure.

FIG. 11B illustrates an example process for providing guidance to a vision impaired individual in accordance with an example of the present disclosure.

FIG. 11C illustrates a process for setting one or more modes for a guidance vest system in accordance with an example of the present disclosure.

FIG. 11D illustrates an example process for setting one or more operating modes of a guide vest in accordance with an example of the present disclosure.

FIG. 12 illustrates an example method for utilizing a guide assist application to enable a guide to maintain situational awareness of an individual using a vest system in accordance with an example of the present disclosure.

While this Brief Description of the Drawings provides an overview of some aspects of inventions described, various further, alternative, and complementary aspects will be appreciated by those of skill in the art on review of the disclosures herein, and as such, this Brief Description of the Drawings should not be deemed to in any way limit the scope or spirit of this application or any application claiming priority to this application.

### DETAILED DESCRIPTION

Some embodiments of the present invention(s) will now be described more fully hereinafter with reference to the accompanying drawings, in which some, but not all embodiments of the invention(s) are shown. Various embodiments of the invention(s) may be embodied in many different forms and should not be construed as limited to the embodiments set forth herein. Like reference numerals refer to like elements throughout.

It is to be understood that the methods and systems described herein are not limited to specific methods, specific components, or to particular implementations. It is also to be understood that the terminology used herein is for the purpose of describing particular embodiments only and is not intended to be limiting.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The present disclosure may enable the user of a guidance device to enhance the ability of vision impaired individuals to participate in one or more physical activities. In some examples, the one or more physical activities may include hiking, running, kayaking, skiing, snowshoeing and biking. The disclosed subject matter may enable the use of a guidance the device to enable the vision impaired individual to ‘feel’ and hear the direction and distance to their guide and make correction adjustments. The disclosed subject matter may reduce a need for the guide to frequently announce directions and may free some of the hearing of the vision impaired individual to enable the individual to enjoy sounds of the environment or chat with a friend. The vision impaired individual may utilize an audio feature of the device that may announce one or more distances and/or directions to turn with a single push of a button.

In an example aspect of the present disclosure, a guide may attach an electronic beacon to their clothing or to a backpack. The beacon may transmit a specialized radio signal. The guide may maintain an out-front distance to also remain within a comfortable hearing range of the vision impaired individual. In another example aspect of the present disclosure, a vision impaired individual may wear a lightweight vest (or life jacket) which may have been fitted with an electronic control and tactile vibration motors. The motors (or shakers) may emit vibrations around the torso based on direction to the guide. When activated, the vest electronics may receive the guide beacon signal, calculate a distance and/or direction to the guide, then apply electrical current to one or more vibration motors that may be closest to the guide. In this way, the vision impaired individual can ‘feel’ the direction to the guide. The vision impaired individual may optionally select modes that will announce tones and/or speech to provide direction and distance guidance.

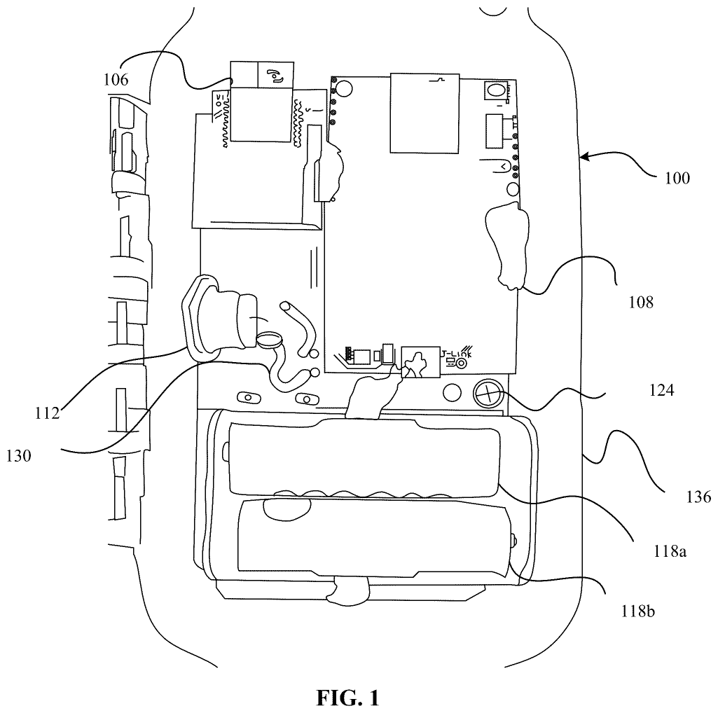

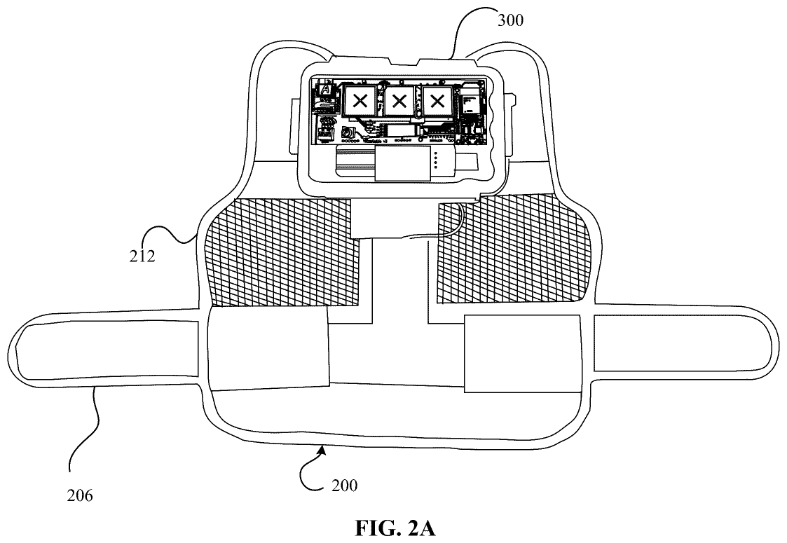

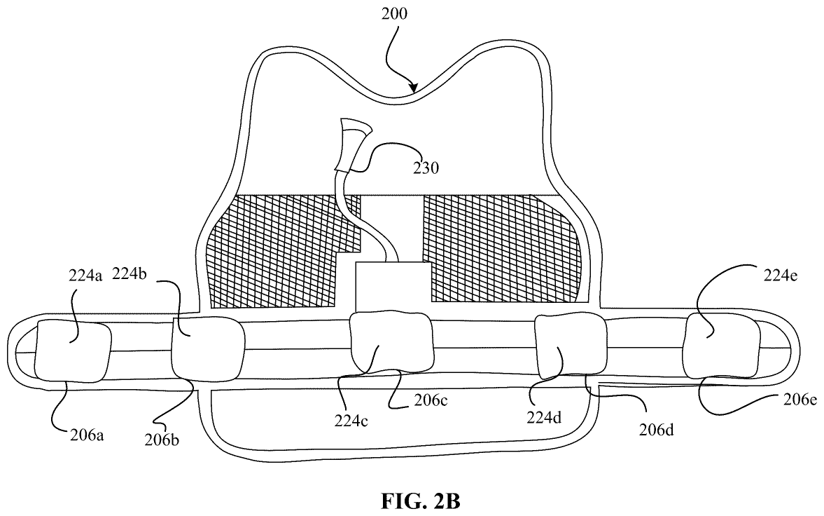

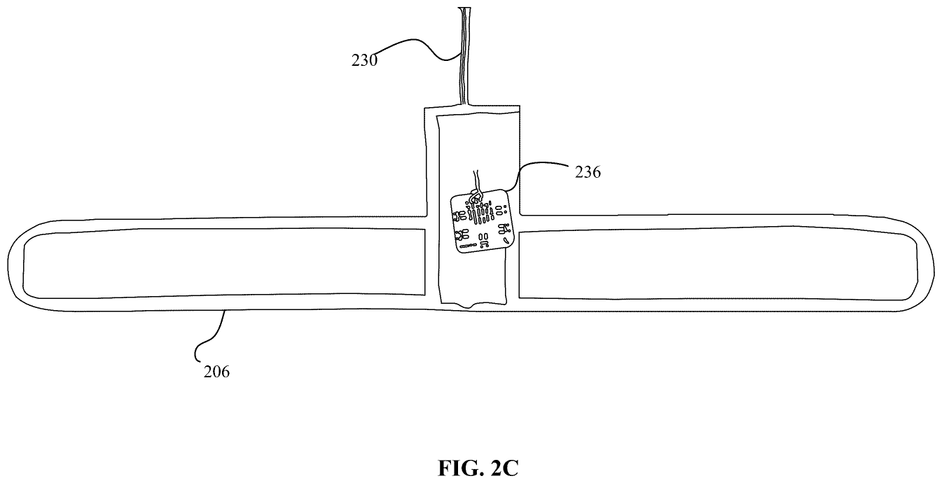

Turning to the drawings, FIG. 1 is a diagram of an example beacon 100 in accordance with an example of the present disclosure. Beacon 100 may be carried by a leading guide and may transmit a direction-finding signal that may be received by vest system 200. In some examples, beacon 100 may be carried on an article of clothing of the guide. For example, the guide may carry beacon 100 on a backpack. At FIG. 1, beacon 100 may be used to emit one or more signals to enable guidance to beacon 100. In some examples, beacon 100 may emit one or more pulses across a spectrum of one or more frequencies that may be received by an offboard system (e.g., vest system 200 of FIGS. 2A and 2B). Discussion of how the offboard system may determine an angle of arrival is included below. As illustrated in FIG. 1, beacon 100 may include ranging component 106. At FIG. 1, ranging component 106 may receive a range query from an offboard system (e.g., vest system 200). In some examples, ranging component 106 may be an ultra-wideband ranging module. In response to the range query, ranging component 106 may transmit a timestamp to the offboard system (e.g., vest system 200). The offboard system (e.g., vest system 200) may determine a time of flight of the signal based on the timestamp and the time the signal was received to calculate the distance from the guide to the vision impaired individual (e.g., the distance from beacon 100 to vest system 200). In this way, ranging component 106 may enable the offboard system to determine a distance to beacon 100. In some examples, the distance calculation may be based on a determination made using an ultra-wideband module. In other examples, the distance calculation may be based on a received signal strength indicator. As illustrated in FIG. 1, beacon 100 may further include transceiver 108. In some examples, transceiver 108 may include one or more Bluetooth 5.1 direction finding angle-of-arrival transceivers. At FIG. 1, transceiver 108 may transmit a signal that may be detected by an offboard system (e.g., vest system 200) to enable the offboard system to determine a direction from the offboard system to beacon 100.

As illustrated in FIG. 1, beacon 100 may further include switch 112. At FIG. 1, switch 112 may enable a user of beacon 100 to power beacon 100 on or off. In some examples, switch 112 may be used for one or more functions other than powering beacon 100 on or off. For example, switch 112 may be used to put beacon 100 into a standby mode where beacon 100 is powered on but not transmitting a guidance signal. For another example, switch 112 may be used to manually run a built-in test for beacon 100. In some examples, switch 112 may be utilized to enable channel selection. In this way, multiple vests, beacons, or vest guidance units may be used in a same physical area.

As illustrated in FIG. 1, beacon 100 may include power source 118. At FIG. 1, power source 118 may be capable of supplying electrical power to beacon 100. For example, power source 118 may include one or more batteries capable of delivering regulated direct current (DC) to beacon 100 and may optionally integrate with external power inputs or energy harvesting modules, depending on the deployment environment. As illustrated in FIG. 1, beacon 100 may include voltage stabilization component 124. Voltage stabilization component 124 may be coupled to power source 118 and may be configured to reduce voltage ripple and/or suppress high-frequency noise generated by other components (including but not limited to downstream components). In some examples, voltage stabilization component 124 may be a subcomponent of power source 118. As illustrated in FIG. 1, beacon 100 may include voltage control element 130. Voltage control element 130 may be configured to maintain a constant output voltage from power source 118. In some examples, voltage control element 130 is a subcomponent of power source 118. As illustrated in FIG. 1, beacon 100 may include enclosure 136. At FIG. 1, enclosure 136 may be a casing that may house and/or protect internal components of beacon 100 (e.g., power source 118, voltage regulator 130, transceiver 108, and/or ranging component 106).

FIGS. 2A and 2B are diagrams of a vest system that may be utilized by a sensory impaired user to participate in one or more activities with the aid of guidance from a device. While FIGS. 2A and 2B depict a vest (and FIG. 2C depicts a belt), it will be understood by those of skill in the art that components disclosed herein can be integrated with any other wearable article, pack, et cetera, or attached to a person, vehicle, accessory, et cetera, or may otherwise be utilized in consolidated or distributed systems providing the advantages described herein. Vest system 200 may receive a signal from beacon 100 to calculate angle and/or distance to the beacon. Vest system 200 may further announce an approximate distance and/or direction to the guide that may be wearing beacon 100. As illustrated in FIGS. 2A and 2B, vest system 200 may include belt 206, which may be attached to vest system 200 and may be used to secure vest system 200 to a user of vest system 200. In some examples, belt 206 may be configured to wrap around a user to attach opposite ends to secure the vest around the user. For example, belt 206 may use a hook and loop system where a first side of belt 206 includes the hook side while a second side includes a loop side, which may be used to connect the belt on opposite ends after wrapping around a user. As illustrated in FIGS. 2A and 2B, vest system 200 may include panel 212. In some examples, vest system 200 may include more than one panel. For example, vest system 200 may include a front and rear panel. In some examples, panel 212 may include a mesh material that may provide some cooling properties for a user of vest system 200. For another example, vest system 200 may include a front panel, rear panel, and two side panels. In some examples, panel 212 may be used to adhere to belt 206 to secure vest 200 around the user. For example, panel 212 may include a hook side while belt 206 includes a loop side, thereby enabling belt 206 to adhere to panel 212 to secure vest system 200 around a user. In some examples, vest system 200 may be used by a sensory impaired user for ground-based activities. For example, vest system 200 may be used by an individual to receive guidance for following a guide for walking or running. In some examples, vest system 200 may be used by an individual to receive guidance for water-based activities. For example, vest system 200 may be a life jacket configured to provide guidance for a sensory impaired individual to follow a guide while kayaking. In this example, vest system 200 may also perform as a safety mechanism if the user falls into the water.

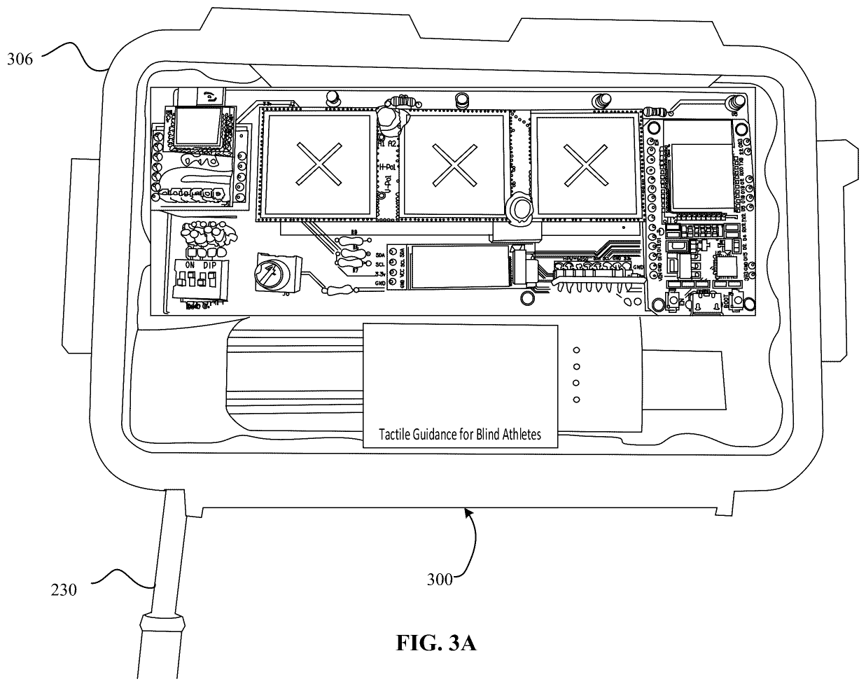

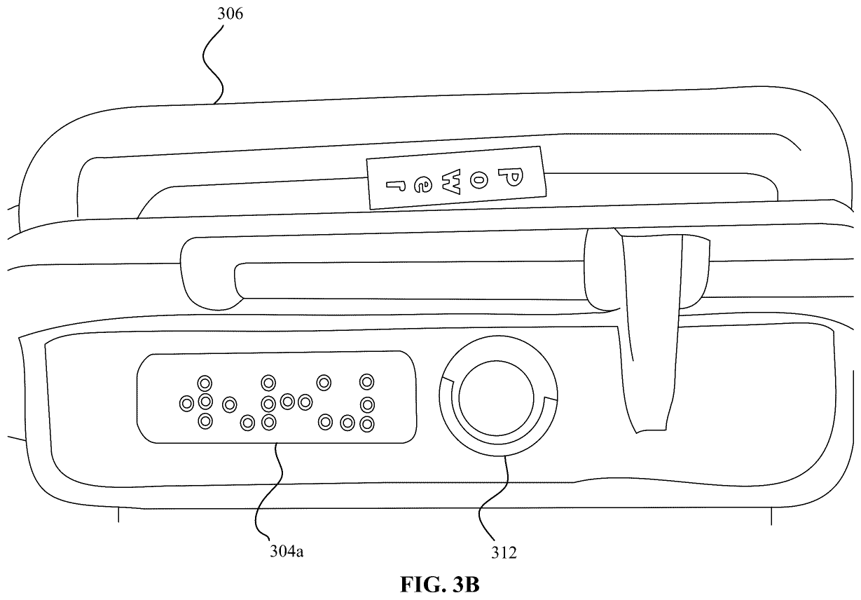

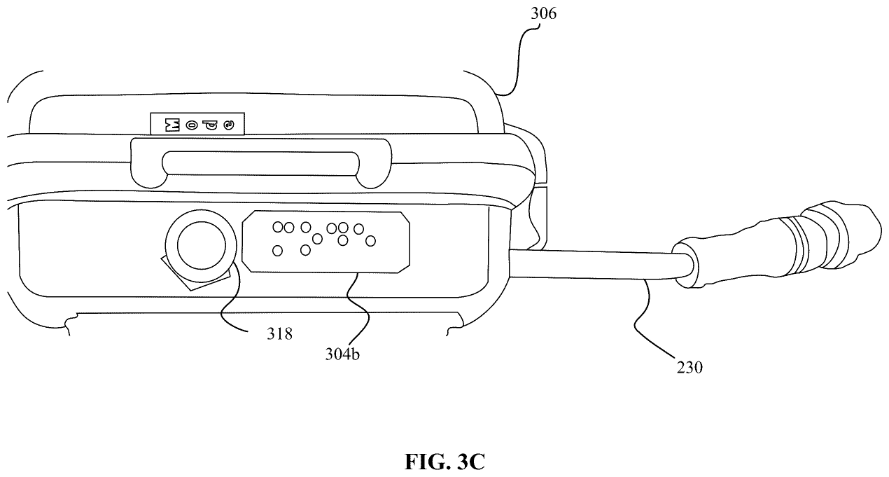

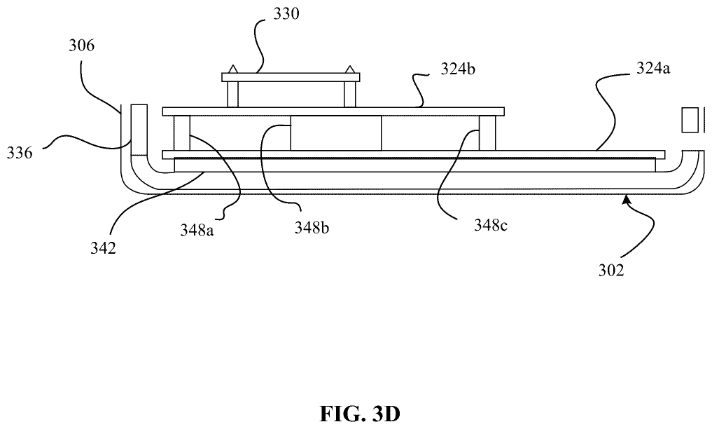

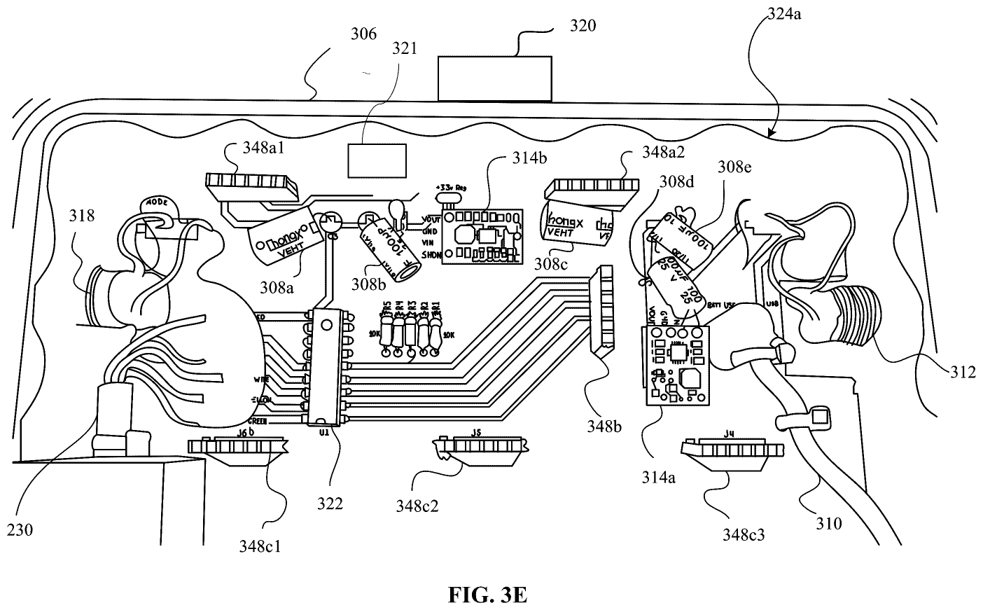

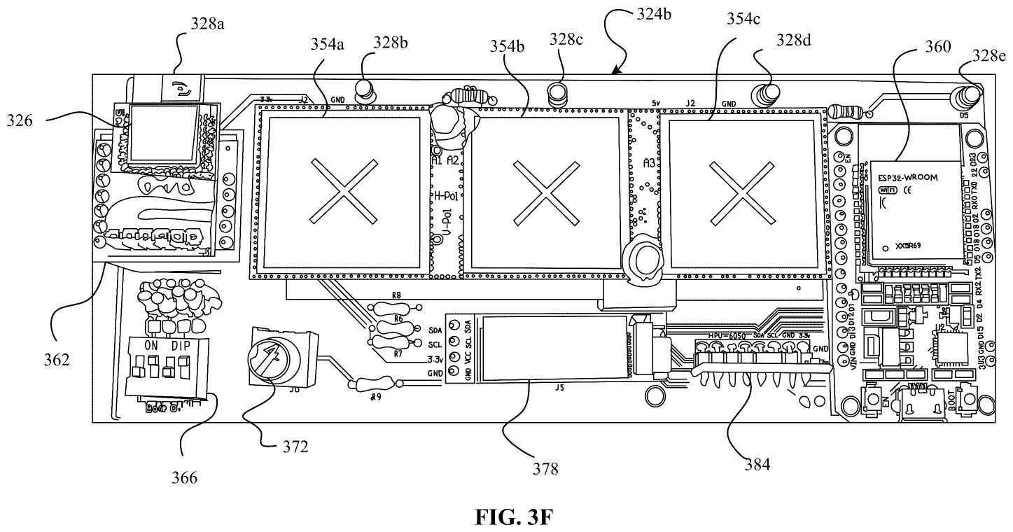

FIG. 2A is a diagram of an outside front panel view of a guidance vest system in accordance with an example of the present disclosure. As illustrated in FIG. 2A, vest system 200 may utilize panel 212 to hold vest guidance unit 300 (see FIGS. 3A-3D). At FIG. 2A, vest guidance unit 300 may be utilized to send and/or receive one or more signals from beacon 100 which may be used to provide distance and/or direction guidance to a user of vest system 200. Vest guidance unit 300 may be discussed further below.

FIG. 2B is a diagram of an inside front panel view of the guidance vest system in accordance with an example of the present disclosure. As illustrated in FIG. 2B, vest system 200 may utilize belt 206 to hold guidance component 224a-224e. As illustrated, belt 206 may include pocket 206a-206e that may be used to hold guidance component 224a-224e. It should be recognized that vest system 200 may include more or less guidance components than guidance component 224a-224e. For example, vest system 200 may include three guidance components. For another example, vest system 200 may include ten guidance components. As illustrated in FIG. 2B, vest system 200 may include cable 230, which may be used to connect vest guidance unit 300 to guidance component 224a-224e. In some examples, cable 230 may be an electronic interconnection cable configured to establish a communication and/or power-transmitting link between vest guidance unit 300 and guidance component 224a-224e. In some examples, cable 230 may include standardized or custom connectors adapted to interface with corresponding ports on vest guidance unit 300 and guidance component 224a-224e. At FIG. 2B, guidance component 224a-224e may include one or more tactile vibration motors. At FIG. 2B, guidance component 224a-224e may be connected via one or more wires to cable 230. In this way, vest guidance unit 300 may transmit one or more signals to guidance component 224a-224e which may cause guidance component 224a-224e to vibrate in a coordinated fashion to provide one or more guidance cues for a user of vest system 200. Put another way, guidance component 224 (a)-224 (e) can provide haptic feedback, which can be directional on the user's body or about a wearable or other means for retaining guidance component 224 (a)-224 (e) to indicate a direction of a beacon in relation thereto. For another example, vest guidance unit 300 may cause the leftmost guidance component(s) (e.g., guidance component 224a and 224b) to vibrate in response to a determination that beacon 100 is left of center of vest guidance unit 300. For yet another example, vest guidance unit 300 may cause the leftmost guidance component(s) (e.g., guidance component 224a and 224b) to vibrate at a frequency of 60 BPM in response to a determination that beacon 100 is left of center of vest guidance unit 300 at a distance of five feet away. In alternative or complementary examples, guidance component 224a-224e may be configured to coordinate vibration patterns based on a distance and/or direction from vest guidance unit 300 to beacon 100. For example, vest guidance unit 300 may cause guidance component 224a-224e to vibrate at a frequency of 60 beats per minute (BPM) in response to determining that there is a distance of five feet between vest guidance unit 300 and beacon 100 and vibrate continuously if the distance is less than five feet (which can, e.g., signal to avoid a collision). For larger distances, a faster frequency may be used to indicate a need to catch up. The frequencies at which the guidance component 224a-224e vibrate can be set according to thresholds or can vary dynamically and continuously (e.g., continuous sliding scale based on distance). In some examples, different types, patterns, series, et cetera, of vibrations can be used at different intervals or as individual signals to convey different details of direction, distance, or other system parameters. Consider an example in which a guide is carrying beacon 100 and a vision impaired individual is wearing vest system 200. In this example, while the individual is following the guide, should the guide change direction or the vision impaired individual veer off course, the vibration pulses of guidance component 224a-224e may shift to the side closest to the guide, which may indicate a correction. As the vision impaired individual turns in that direction and becomes aligned with the guide, the pulses may shift back to the front of the vest. If a guide quickly stops or slows down while the vision impaired individual is still traveling, this may result in rapid increase in pulses as the vision impaired individual gets closer to the guide.

FIG. 2C is a diagram of belt 206 in accordance with an example of the present disclosure. In some examples, cable 230 may include more than one piece. For example, cable 230 may be a part of belt 206 and may attach to a separate cable included in vest guidance unit 300. In this way, belt 206 may be switched out with another belt or a different attachment that may be connected to vest guidance unit 300 via the cable. As illustrated in FIG. 2C, belt 206 may include hub 236. In some examples, guidance component 224a-224e and cable 230 may be wired to hub 236. In this way, hub 236 may serve as a central element at which the wires from guidance component 224a-224e may meet to be neatly wired to cable 230.

FIGS. 3A-3F are diagrams of an example vest guidance unit 300 in accordance with an example of the present disclosure. As illustrated in FIGS. 3A-3F, vest guidance unit 300 may include enclosure 306. In some examples, enclosure 306 may provide environmental protection (e.g., from moisture, temperature, contaminants, et cetera), mechanical protection (e.g., impact dampening, vibration, acceleration, et cetera), and/or electromagnetic shielding (e.g., from external or internal sources) for one or more internal components of vest guidance unit 300. In some examples, enclosure 306 may include one or more holes that may be waterproofed, which may enable the use of vest guidance unit 300 in water activities. For example, the holes can accommodate hermetically sealed buttons or other controls, wires to vibrating or other signaling elements, other wires or cable routing, antennae, mounting or attaching of components, drainage in the event of fluid intrusion (if a one-way valve is used), and other purposes. It should be recognized that vest guidance unit 300 may be used as separately from vest system 200. For example, vest guidance unit 300 may be used as a standalone system. For another example, vest guidance unit 300 may be attached to life vest. In these examples, vest guidance unit 300 may perform similarly to the description herein. At FIGS. 3A-3F, should vest guidance unit 300 lose contact with beacon 100 due to an obstacle, battery drain, or range exceed maximum, vest guidance unit 300 may make an announcement (e.g., “radios out”), using audio device 320, and cause guidance component 224a-224e to pulse.

FIG. 3A is a diagram of an example vest guidance unit 300 in accordance with an example of the present disclosure. Vest guidance unit 300 may be included on vest system 200 (e.g., as illustrated in FIG. 2A. In some examples, vest guidance unit 300 may be separate from vest system 200, and may be attached to vest system 200. For example, one or more sides of enclosure 306 may include hook backing (e.g., from a hook and loop system) that may be used to attach vest guidance unit 300 to vest system 200. As illustrated in FIG. 3A, vest guidance unit 300 may be connected to cable 230. In this way, vest guidance unit 300 may be electronically connected to guidance component 224a-224e. In some examples, vest guidance unit 300 may include a cable with a male or female plug that may be used to attach vest guidance unit 300 to cable 230. The components that may be contained in enclosure 306, as a part of vest guidance unit 300, are discussed below.

FIG. 3B is a diagram of a first side view of vest guidance unit 300 in accordance with an example of the present disclosure. As illustrated in FIG. 3B, the first side of vest guidance unit 300 may include button 312. At FIG. 3B, button 312 may be a power switch that may be used to power vest guidance unit 300 on or off. It should be recognized that button 312 may be configured to perform one or more functions other than those of a power switch. For example, button 312 may be configured to cause vest guidance unit 300 to enter a pairing mode that may enable vest guidance unit 300 to be paired with beacon 100. As illustrated in FIG. 3B, the first side of vest guidance unit 300 may include panel 304a containing one or more tactile indicators. In some examples, panel 304a may be adjacent to button 312 to enable a sensory impaired user to identify button 312. For example, panel 304a may include a Braille label which may be used by a user with visual impairments to enable the user to identify button 312 and one or more functions of button 312.

FIG. 3C is a diagram of a second side view of vest guidance unit 300 in accordance with an example of the present disclosure. In some examples, the second side of vest guidance unit 300 is different from the first side of vest guidance unit 300. As illustrated in FIG. 3C, the second side of vest guidance unit 300 may include button 318. At FIG. 3C, button 318 may be a mode switch that may enable a user to enable a squawk mode, tone mode or glide mode. A squawk mode may include enabling vest guidance unit 300 to make an audio announcement of distance and/or direction instructions from vest system 200 to the guide. Tone mode may include pulsing a tone when vest guidance unit 300 is centered on the guide to indicate to the vest wearer when a center point is reached and to prevent the vest wearer from oversteering when executing a turn. Glide mode may include enabling vest guidance unit 300 to pulse a tone that may vary based on a distance and/or direction to the guide. For example, a mid-range audible tone may pulse when vest guidance unit 300 is centered on the guide. For another example, as the distance between vest system 200 and beacon 100 increases, vest guidance unit 300 may increase the pulse interval and audible frequency of the tones. Glide mode may include pulsing when vest guidance unit 300 is centered on the guide; pulsing a high-pitched tone when vest guidance unit 300 is approaching a “glide area”; and emitting a low-pitched tone when vest guidance unit 300 drifts back from the glide area. In some examples, the glide area may include a distance from the glide. For example, the glide area may be five feet plus or minus two feet from the glide. In some examples, button 318 may enable a user to enable or disable one or more announcements of direction and/or distance from the user to a guide. In some examples, button 318 may enable a user to vary an intensity of vibrations felt from vest system 200 (e.g., via vibration component 224a-224e). For example, button 318 may enable a user to set the vibration intensity of vibration component 224a-224e to 50%. At FIG. 3C, button 318 may detect one or more inputs from a user. At FIG. 3C, in response to the one or more inputs, button 318 may adjust one or more settings of vest system 200. For example, in response to a user pressing and holding button 318, vest system 200 may adjust the vibration intensity of vibration component 224a-224e. For another example, in response to a single press and release of button 318, vest system 200 may run a built-in test. In some examples, vest guidance unit 300 may include channel selection. Channel selection may enable the use of multiple vests, beacons, and/or vest guidance units in the same physical area. In these examples, button 318 may be utilized to select one or more channels. As illustrated in FIG. 3C, vest guidance unit 300 may include panel 304b. In some examples, panel 304b may be adjacent to button 318 to enable a sensory impaired user to identify button 318. For example, panel 304b may include a Braille label which may be used by a user with visual impairments to enable the user to identify button 318 and one or more functions of button 318.

FIG. 3D is a diagram of an example circuit board stack 302 of vest guidance unit 300 in accordance with an example of the present disclosure. In some examples, circuit board stack 302 may be a printed circuit board stack included inside enclosure 306 of vest guidance unit 300. As illustrated in FIG. 3D, circuit board stack 302 may include pin header 348a-348c, which may be used to connect one or more components of circuit board stack 302 in order to hold it together. As illustrated in FIG. 3D, circuit board stack 302 may further include shock pad 336, which may be used to absorb vibrations or impacts in order to protect the components and/or integrity of circuit board stack 302. In this way, a user of vest guidance unit 300 may perform while minimizing damage from vibration or shock. In some examples, shock pad 336 may include one or more materials designed to absorb vibration. For example, shock pad 336 may be made of rubber. As illustrated in FIG. 3D, circuit board stack 302 may include mounting component 342, which may be used to adhere one or more circuit boards to vest guidance unit 300. In some examples, mounting component 342 may include a double-sided adhesive foam for mounting the one or more circuit boards. As illustrated in FIG. 3D, circuit board stack 302 may include circuit board 324a and 324b. Circuit board 324a and 324b are discussed further below. Circuit board stack 302 may further include antenna 330. Antenna 330 is discussed further below.

FIG. 3E is a diagram of an example circuit board 324a in accordance with an example of the present disclosure. As illustrated in FIG. 3E, circuit board 324a may include pin header 348a1, 348a2, 348b, and 348c1-348c3, which may perform similarly to pin header 348a-348c as described herein. As illustrated in FIG. 3E, circuit board 324a may include an end point of cable 230, thereby serving as the physical and electronic connection point of vest guidance unit 300 to cable 230. As illustrated in FIG. 3E, cable 230 may further be connected to array 322. At FIG. 3E, array 322 may control electrical current through guidance component 224a-224e. As illustrated in FIG. 3E, button 312 and 318, respectively, may be connected to circuit board 324a. In this way, the control of power or mode switching for vest guidance unit 300 may be performed using circuit board 324a. As illustrated in FIG. 3E, circuit board 324a may further include voltage stabilization component 308a-308e. At FIG. 3E, voltage stabilization component 308a-308e may be configured to reduce voltage ripple and/or suppress high-frequency noise generated by downstream components. In some examples, voltage stabilization component 308a-308e may include one or more filter capacitors. As illustrated in FIG. 3E, circuit board 324a may further include voltage control element 314a and 314b. At FIG. 3E, voltage control element 314a and 314b may be configured to maintain a constant voltage across one or more components of circuit boards 324a. In some examples, voltage control element 314a and/or 314b may be configured to provide step-up voltage regulator or step-down voltage regulation and filtering. As illustrated in FIG. 3E, circuit board 324a may further include cable 310. In some examples, cable 310 may connect circuit board 324a to a power source. For example, cable 310 may connect circuit board 324a to a battery.

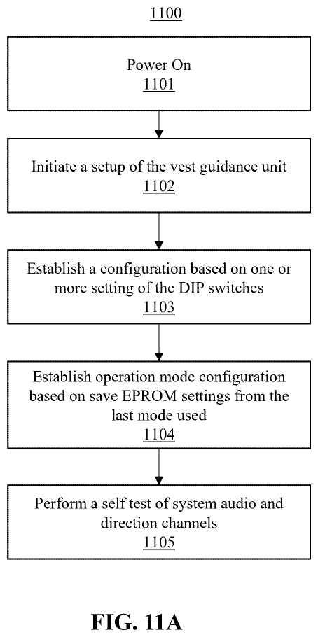

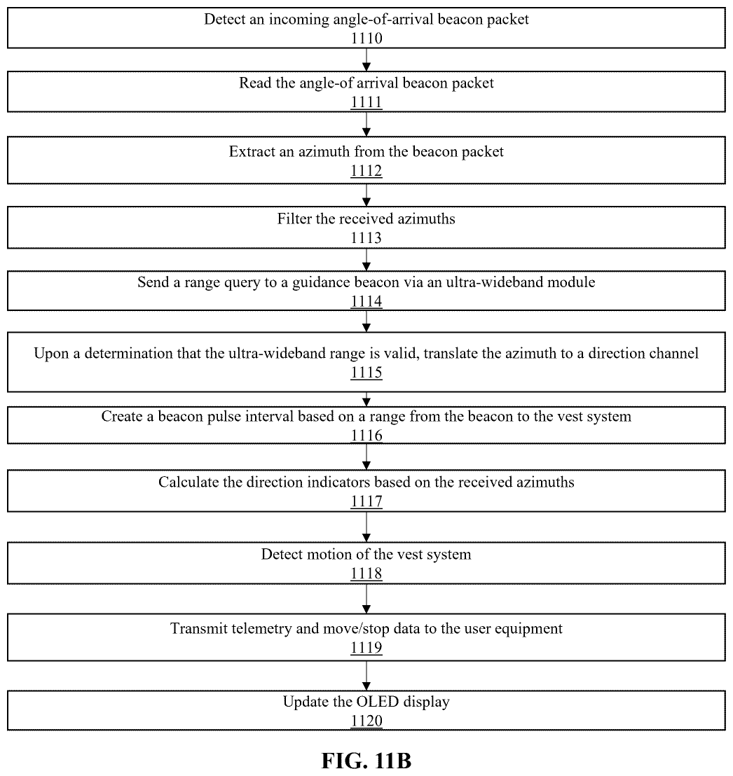

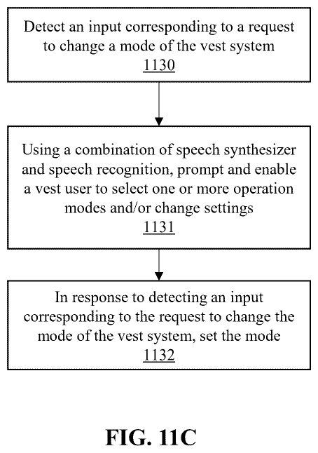

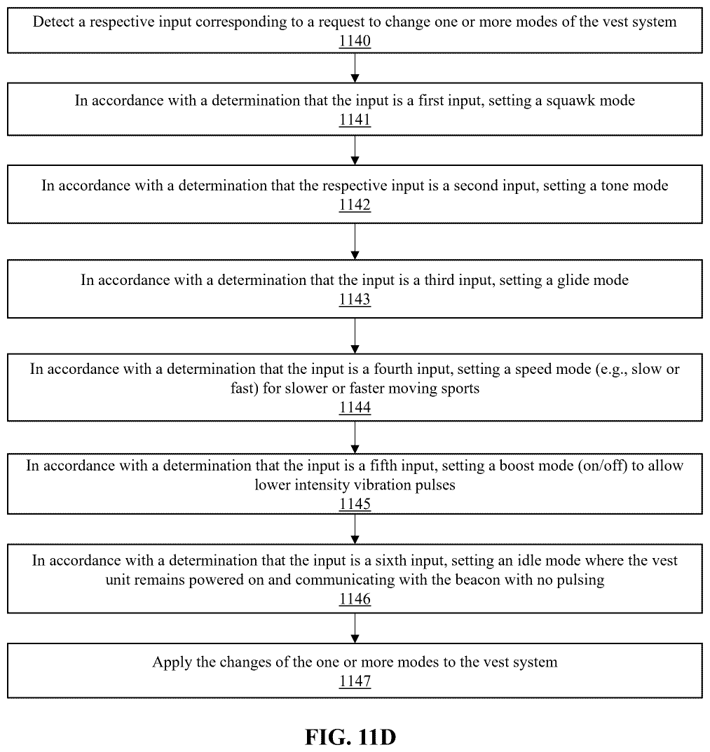

In addition to button 318, vest guidance unit 300 may support a voice-activated interface to enable the user of vest system 200 to configure one or more settings and/or operate one or more functions through speech commands. In this way, vest guidance unit 300 may provide a hands-free, accessible alternative to the traditional manual controls. As illustrated in FIG. 3E, circuit board 324a may further include audio device 320. In some examples, audio device 320 may be used by vest guidance unit 300 to provide one or more guidance commands to a sensory impaired user of vest system 200. For example, vest guidance unit 300 may utilize audio device 320 to provide one or more audio commands to guide a blind user of vest system 200 with guidance to follow a guide. As illustrated in FIG. 3E, circuit board 324a may further include audio input device 321. In some examples, audio device 321 may be used by vest guidance unit 300 to accept speech commands from a sensor impaired user of vest system 200. For example, vest guidance unit 300 may utilize audio input device 321 to accept one or more speech commands to change an operational mode and/or to reconfigure vest system 200. In addition to selecting modes and options via mode button 318, a speech recognition module may enable a user of vest system 200 to verbally make selections using audio input device 321. In some examples, the user may use one or more preprogrammed commands to adjust one or more modes and/or options for operating vest system 200. For example, the user may use keyword “VEST” followed by a mode name such as “SQUAWK,” “TONE,” “GLIDE,” “BOOST,” “SPEED” or “IDLE” followed by an action “ON” or “OFF” in order to verbally make selections followed by a confirmation using audio device 320. For another example, the user of vest system 200 may say “VEST TONE ON” to enable the Tone mode as an alternative to pressing the mode button a second time (as described in step 1142 of FIG. 11D). For yet another example, the user of vest system 200 may say “VEST BOOST OFF” as an alternative to pressing button 318 a fifth time (as described in step 1145 of FIG. 11D) to cause the vibration intensity to be reduced by 50%. In some examples, audio input device 321 may use natural language processing to understand the speech of the user of vest system 200 to understand the commands from the user to adjust the one or more options and/or modes.

In some examples, audio input device 321 may utilize wake word activation. In this way, vest guidance unit 300 may stay in a low-power mode until it hears a specific wake word. Wake word activation may provide an alternative to the use of button 312 to power vest guidance unit on or off. In other examples, vest guidance unit 300 may utilize multimodal interaction to combine voice inputs, using audio input device 321, and other inputs using button 312. In these examples, vest guidance unit 300 may utilize cloud-based or on-device processing to process voice data provided to audio input device 321. For cloud-based processing, the user of vest system 200 may provide a voice input to audio input device 321. After receiving the voice input, vest guidance unit 300 may capture the audio input using audio input device 321, encode the audio input, wrap the audio input in a data packet, and transmit the packet using network 455 to a server (e.g., server 472). The server may return a text transcription, intent, or command using network 455 to vest guidance unit 300. In response to receiving the returned information, vest guidance unit 300 may adjust the one or more settings and/or modes.

In various embodiments speech recognition can use local or cloud based comparisons of captured audio to match particular words, or may use language processing (including natural language processing or other language processing techniques) to interpret spoken words and generate a command or response based thereon. Alternative or combinations of techniques can be used to enable speech or other handsfree operation of one or more aspects of systems and methods described herein without departing from the scope or spirit of the innovation.

FIG. 3F is a diagram of an example circuit board 324b in accordance with an example of the present disclosure. As illustrated in FIG. 3F, circuit board 324b may include processor 360. In some examples, processor 360 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. At FIG. 3F, processor 360 may be an ESP32 microcontroller configured for low-power wireless communication and embedded control applications. Processor 360 may include one or more processing cores, integrated memory, and a set of peripheral interfaces. At FIG. 3F, processor 360 may include built-in support for wireless communication protocols, such as IEEE 802.11 and Bluetooth, including Bluetooth low energy, which may enable it to transmit and receive data over short-range wireless networks. In general, processor 360 may execute computer-executable instructions stored in the memory of vest guidance unit 300 in order to perform the various required functions of vest guidance unit 300. For example, the processor 360 may perform signal coding, data processing, power control, input/output processing, and/or any other functionality that enables the vest guidance unit 300 to operate in a wireless or wired environment. Processor 360 is coupled to its communication circuitry (e.g., ranging component 326 and antenna 354a-354c). Processor 360, through the execution of computer executable instructions, may control the communication circuitry in order to cause the vest guidance unit 300 to communicate with beacon 100 or UE 500 via the network to which it is connected.

As illustrated in FIG. 3F, circuit board 324b may further include ranging component 326. In some examples, ranging component 326 may be configured to receive a signal from beacon 100 to determine a distance from vest guidance unit 300 to beacon 100. At FIG. 3F, ranging component 326 may receive a signal from beacon 100 that may include a timestamp. After receiving the signal with a timestamp from beacon 100, vest guidance unit 300 may determine the time of receipt of the signal and, based on a determination of the time of flight (e.g., the difference between the timestamp and the time of receipt of the signal), vest guidance unit 300 may determine the range from vest system 200 to beacon 100. As illustrated in FIG. 3F, circuit board 324b may further include amplifier component 362. In some examples, amplifier component 362 may be configured to increase power of audio signals in order to drive audio device 320 and produce sound at a range of volumes. As illustrated in FIG. 3F, circuit board 324b may further include switch 366. In some examples, switch 366 may be a four-position switch in which each position may correspond to one or more settings. For example, the four positions may correspond to pulse interval value settings, Bluetooth channel settings, configuration settings, and/or transmission settings of data to a mobile application.

At FIG. 3F, switch 366 may be checked during power-on or boot-up of vest guidance unit 300 to set one or more global Boolean variables that may affect operation or reloading of one or more settings to one or more modules of vest guidance unit 300. At FIG. 3F, an input directed to updating a pulse setting may be used to set the pulse settings on, setting the low range of pulse intervals, and/or a top range of pulse intervals. The pulse intervals may intervals may determine the rate of vibration of guidance component 224a-224e and/or indicator 328a-328e. In this way, an activity that may require a faster response in vest system 200 may be successfully undertaken while providing guidance to a vision impaired individual. It should be recognized that switch 366 may include more than one switch. For example, switch 366 may include five switches. It should further be recognized that switch 366 may include more or less positions than four. For example, switch 366 may include seven positions. At FIG. 3F, switch 366 may detect an input corresponding to a request to filter Wi-Fi or Bluetooth channels. In some examples, filtering the Wi-Fi or Bluetooth channels may include reducing multipath errors, removing azimuths from Wi-Fi channels, and/or applying a median average filter. For example, vest guidance unit 300 may compare a previous and new azimuth. In this example, if the difference is greater than a predefined margin of error, then a gyroscope angular velocity may be checked to determine if a turn is taken place. If vest guidance unit 300 detects that vest system 200 is turning, vest guidance unit 300 may accept the new azimuth. If vest guidance unit 300 detects no turn, vest guidance unit 300 may reject the new azimuth. For another example, vest guidance unit 300 may receive an azimuth packets channel and compare the azimuth packets channel against a table of accept/reject channels. In response to a determination that the packets channel is designated to ignore, vest guidance unit 300 may use the last valid azimuth. For yet another example, vest guidance unit 300 may apply each valid azimuth value to a three-position circular median average filter for smoothing. In some examples, switch 366 may be set to reduce standard Bluetooth channel hopping to ignore channels shared with Wi-Fi. In this way, signal conflicts may be reduced if direction finding does not include channel blocking. At FIG. 3F, switch 366 may detect an input corresponding to a request to configure modules corresponding to ultra-wideband ranging or antenna 354a-354c. In some examples, ultra-wideband ranging and/or antenna 354a-354c may include configuration setting that may be programmed with one or more commands. In some examples, switch 366 may cause the modules to reload their respective one or more commands before continuing with a boot-up. At FIG. 3F, switch 366 may detect an input corresponding to a request to enable or disable sharing of telemetry data from vest guidance unit 300 to UE 500. In this way, by disabling sharing of the data, battery power of vest guidance unit 300 may be conserved.

As illustrated in FIG. 3F, circuit board 324b may further include control 372. At FIG. 3F, control 372 may be used to control the volume of sound from audio device 320. In some examples, control 372 may be a rotary knob. For example, turning control 372 clockwise may cause the volume of audio device 320 to increase. In other examples, control 372 may be a potentiometer. As illustrated in FIG. 3F, circuit board 324b may further include sensor 384. At FIG. 3F, sensor 384 may be an accelerometer configured to detect movement of vest system 200.

As illustrated in FIG. 3F, circuit board 324b may include indicator 328a-328e. At FIG. 3F, indicator 328a-328e may be configured to provide visual directional cues through selective illumination patterns. In some examples, indicator 328a-328e may be colored based on their positioning, thereby providing directional cues based on the color and position of the indicator. For example, indicator 328a-328e may be colored and positioned as follows: indicator 328a and 328b may be the rightmost positioned and colored green; indicator 328c may be positioned in the center and colored white; and indicator 328d and 328e may be the leftmost positioned and colored red. In this example, based on a determination that the user of the vest may need to turn right, indicator 328a and 328b may light green to direct the user to turn right. For another example, a slight right turn may be cued by indicator 328b lighting green, while an extreme right turn may be cued by indicator 328a and 328b lighting green. In other examples, indicator 328a-328e may all be colored white. In these examples, a directional cue may be based on the position of the lighted indicator. For example, indicator 328d and 328e may light white to provide a cue for the user to turn left. It should be recognized that circuit board 324b may have more or less visual indicators than indictor 328a-328e. For example, circuit board 324b may include three indicators. At FIG. 3F, indicator 328a-328e may be utilized by vest guidance unit 300 to provide distance cues to the user of vest system 200. In some examples, vest guidance unit 300 may utilize ranging component 326 to determine a range from vest system 200 to beacon 100. In response to the determination of the range, vest guidance unit 300 may utilize indicator 328a-328e to illuminate in a pattern to indicate the range to beacon 100. For example, based on a determination that vest system 200 is five feet away from beacon 100, vest guidance unit 300 may cause indicator 328a-328e to illuminate at a rate of two beats per second. For another example, based on a determination that vest system 200 is ten feet away from beacon 100, vest guidance unit 300 may cause indicator 328a-328e to illuminate at a rate of one beat per second. At FIG. 3F, vest guidance unit 300 may illuminate indicator 328a-328e in one or more patterns to provide distance and direction cues. For example, in response to a determination that beacon 100 is five feet away and to the left (e.g., determining that the user of vest system 200 may need to turn left), vest guidance unit 300 may cause indicator 328d and 328e (e.g., the leftmost indicators) to illuminate red at a rate of two beats per second.

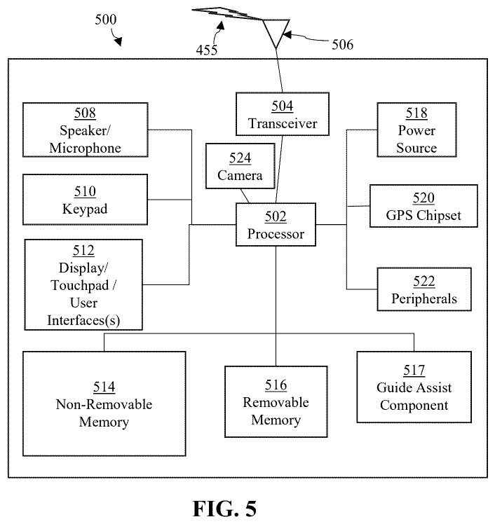

As illustrated in FIG. 3F, circuit board 324b may further include antenna 354a-354c. At FIG. 3F, antenna 354a-354c may be configured to receive a signal from beacon 100. In response to detecting the signal from beacon 100, vest guidance unit 300 may utilize antenna 354a-354c to determine an angle of arrival of the signal. In some examples, antenna 354a-354c may include a phase different antenna array. At FIG. 3F, antenna 354a-354c may each receive the signal at a different time and/or phase. Vest guidance unit 300 may determine the angle of arrival of the signal based on the time and/or phase of receipt of the signal by each of antenna 354a-354c. Based on the angle of arrival, vest guidance unit 300 may determine the direction of beacon 100 from vest system 200. At FIG. 3F, based on a determination of the direction of beacon 100 from vest system 200, vest guidance unit 300 may cause indicator 328a-328e to illuminate in a pattern to provide directional cues for a user of vest system 200. In some examples, antenna 354a-354c may be configured as a board that includes antenna 354a-354c. In these examples, antenna 354a-354c may receive Bluetooth energy to determine an angle of arrival. Antenna 354a-354c may then output final angle information that may be used in an application (e.g., guide assist component 517 from FIG. 5). At FIG. 3F, a module corresponding to antenna 354a-354c may stream packets indicating one or more azimuths to beacon 100. In some examples, the module corresponding to antenna 354a-354c may further stream an RSSI to beacon 100. At FIG. 3F, vest guidance unit 300 may break one or more azimuth ranges into five segments (e.g., −90 degrees to −45 degrees; −45 degrees to −20 degrees; −20 degrees to 20 degrees; 20 degrees to 45 degrees; and 45 degrees to 90 degrees). In some examples, based on a received signal from beacon 100, vest guidance unit 300 may utilize a C++ code interpretation to determine the direction to beacon 100. For example, for a signal at an azimuth greater than 45 degrees, vest guidance unit 300 may determine the direction to beacon 100 to be to the far right. For another example, for a signal at an azimuth less than −45 degrees, vest guidance unit 300 may determine the direction to beacon 100 to be far left. For yet another example, for a signal at an azimuth between −20 degrees and −45 degrees, vest guidance unit 300 may determine the direction to beacon 100 to be left. For yet another example, for a signal at an azimuth of 20 degrees to 45 degrees, vest guidance unit 300 may determine the direction to beacon 100 to be right. For yet another example, for a signal at an azimuth of −20 degrees to 20 degrees, vest guidance unit 300 may determine the direction to beacon 100 to be center. As illustrated in FIG. 3F, circuit board 324b may further include display 378. At FIG. 3F, display 378 may be configured to provide diagnostic information to a user of vest system 200. In some examples, display 378 may provide a signal strength of beacon 100, an azimuth to beacon 100, a distance to beacon 100, distance calculation method (e.g., ultra-wideband module or Receive Signal Strength (RSSI) based distance), and/or a name for vest guidance unit 300 that may be used for Bluetooth pairing. In some examples, the distance to beacon 100 may default to a unit of measurement (e.g., feet). In some examples, the RSSI based distance calculation may be an estimate that is calculated based on a dBm strength of a signal from beacon 100.

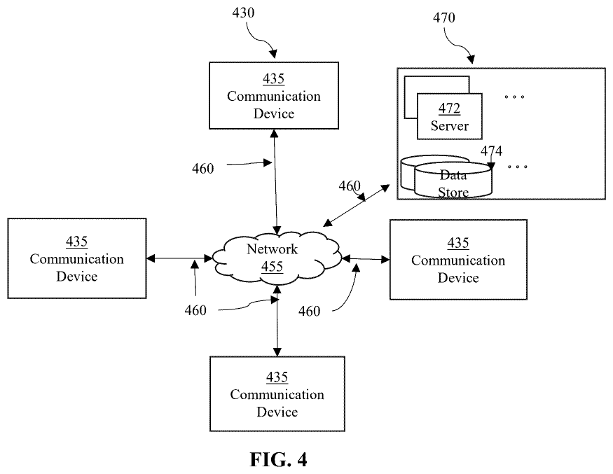

Reference is now made to FIG. 4, which is a block diagram of a system according to example embodiments. As shown in FIG. 4, the system 430 may include one or more communication devices 435 and a network device 470. Additionally, the system 430 may include any suitable network such as, for example, network 455. In other examples, the network 455 may be any suitable network capable of provisioning content and/or facilitating communications among entities within or associated with the network. As an example and not by way of limitation, one or more portions of network 455 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 455 may include one or more networks 455.

Links 460 may connect the communication devices 435 to network 455, network device 470 and/or to each other. This disclosure contemplates any suitable links 460. In some example embodiments, one or more links 460 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some example embodiments, one or more links 460 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 460, or a combination of two or more such links 460. Links 460 need not necessarily be the same throughout system 430. One or more first links 460 may differ in one or more respects from one or more second links 460.

In some example embodiments, communication devices 435 may be electronic devices including hardware, software, or embedded logic components or a combination of two or more such components and capable of carrying out the appropriate functionalities implemented or supported by the communication devices 435. As an example, and not by way of limitation, the communication devices 435 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, vest guidance unit 300, or any other suitable electronic device, or any suitable combination thereof. The communication devices 435 may enable one or more users to access network 455. The communication devices 435 may enable a user(s) to communicate with other users at other communication devices 435.

Network device 470 may be accessed by the other components of system 430 either directly or via network 455. As an example, and not by way of limitation, communication devices 435 may access network device 470 using a web browser or a native application associated with network device 470 (e.g., a mobile social-networking application, a messaging application, another suitable application, or any combination thereof) either directly or via network 455. In particular example embodiments, network device 470 may include one or more servers 472. Each server 472 may be a unitary server or a distributed server spanning multiple computers or multiple datacenters. Servers 472 may be of various types, such as, for example and without limitation, web server, news server, mail server, message server, advertising server, file server, application server, exchange server, database server, proxy server, another server suitable for performing functions or processes described herein, or any combination thereof. In particular example embodiments, each server 472 may include hardware, software, or embedded logic components or a combination of two or more such components for carrying out the appropriate functionalities implemented and/or supported by server 472. In particular example embodiments, network device 470 may include one or more data stores 474. Data stores 474 may be used to store various types of information. In particular example embodiments, the information stored in data stores 474 may be organized according to specific data structures. In particular example embodiments, each data store 474 may be a relational, columnar, correlation, or other suitable database. Although this disclosure describes or illustrates particular types of databases, this disclosure contemplates any suitable types of databases. Particular example embodiments may provide interfaces that enable communication devices 435 and/or another system (e.g., a third-party system) to manage, retrieve, modify, add, or delete, the information stored in data store 474.

Network device 470 may provide users of the system 430 the ability to communicate and interact with other users. In particular example embodiments, network device 470 may provide users with the ability to take actions on various types of items or objects, supported by network device 470. In particular example embodiments, network device 470 may be capable of linking a variety of entities. As an example, and not by way of limitation, network device 470 may enable users to interact with each other as well as receive content from other systems (e.g., third-party systems) or other entities, or to allow users to interact with these entities through an application programming interfaces (API) or other communication channels.

It should be pointed out that although FIG. 4 shows one network device 470 and four communication devices 435, any suitable number of network devices 470 and communication devices 435 may be part of the system of FIG. 4 without departing from the spirit and scope of the present disclosure.

FIG. 5 illustrates a block diagram of an example hardware/software architecture of a communication device such as, for example, user equipment (UE) 500. In some example aspects, the UE 500 may be any of communication devices 435. In some example aspects, the UE 500 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 5, the UE 500 (also referred to herein as node 500) may include a processor 502, non-removable memory 514, removable memory 516, a speaker/microphone 508, a keypad 510, a display, touchpad, and/or user interface(s) 512, a power source 518, a global positioning system (GPS) chipset 520, and other peripherals 522. In some example aspects, the display, touchpad, and/or user interface(s) 512 may be referred to herein as display/touchpad/user interface(s) 512. The display/touchpad/user interface(s) 512 may include a user interface capable of presenting one or more content items and/or capturing input of one or more user interactions/actions associated with the user interface. The power source 518 may be capable of receiving electric power for supplying electric power to the UE 500. For example, the power source 518 may include an alternating current to direct current (AC-to-DC) converter allowing the power source 518 to be connected/plugged to an AC electrical receptable and/or Universal Serial Bus (USB) port for receiving electric power. The UE 500 may also include a camera 524. In an example embodiment, the camera 524 may be a smart camera configured to sense images/video appearing within one or more bounding boxes. The UE 500 may also include communication circuitry, such as a transceiver 504 and a transmit/receive element 506. It will be appreciated the UE 500 may include any sub-combination of the foregoing elements while remaining consistent with an embodiment.

The processor 502 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 502 may execute computer-executable instructions stored in the memory (e.g., non-removable memory 514 and/or removable memory 516) of the node 500 in order to perform the various required functions of the node. For example, the processor 502 may perform signal coding, data processing, power control, input/output processing, and/or any other functionality that enables the node 500 to operate in a wireless or wired environment. The processor 502 may run application-layer programs (e.g., browsers) and/or radio access-layer (RAN) programs and/or other communications programs. The processor 502 may also perform security operations such as authentication, security key agreement, and/or cryptographic operations, such as at the access-layer and/or application layer for example.

The processor 502 is coupled to its communication circuitry (e.g., transceiver 504 and transmit/receive element 506). The processor 502, through the execution of computer executable instructions, may control the communication circuitry in order to cause the node 500 to communicate with other nodes via the network to which it is connected.

The transmit/receive element 506 may be configured to transmit signals to, or receive signals from, other nodes or networking equipment. For example, in an example embodiment, the transmit/receive element 506 may be an antenna configured to transmit and/or receive radio frequency (RF) signals. The transmit/receive element 506 may support various networks and air interfaces, such as wireless local area network (WLAN), wireless personal area network (WPAN), cellular, and the like. In yet another example embodiment, the transmit/receive element 506 may be configured to transmit and/or receive both RF and light signals. It will be appreciated that the transmit/receive element 506 may be configured to transmit and/or receive any combination of wireless or wired signals.

The transceiver 504 may be configured to modulate the signals that are to be transmitted by the transmit/receive element 506 and to demodulate the signals that are received by the transmit/receive element 506. As noted above, the node 500 may have multi-mode capabilities. Thus, the transceiver 504 may include multiple transceivers for enabling the node 500 to communicate via multiple radio access technologies (RATs), such as universal terrestrial radio access (UTRA) and Institute of Electrical and Electronics Engineers (IEEE 802.11), for example.

The processor 502 may access information from, and store data in, any type of suitable memory, such as the non-removable memory 514 and/or the removable memory 516. For example, the processor 502 may store session context in its memory, (e.g., non-removable memory 514 and/or removable memory 516) as described above. The non-removable memory 514 may include RAM, ROM, a hard disk, or any other type of memory storage device. The removable memory 516 may include a subscriber identity module (SIM) card, a memory stick, a secure digital (SD) memory card, and the like. In other example embodiments, the processor 502 may access information from, and store data in, memory that is not physically located on the node 500, such as on a server or a home computer.

The processor 502 may receive power from the power source 518 and may be configured to distribute and/or control the power to the other components in the node 500. The power source 518 may be any suitable device for powering the node 500. For example, the power source 518 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 502 may also be coupled to the GPS chipset 520, which may be configured to provide location information (e.g., longitude and latitude) regarding the current location of the node 500. It will be appreciated that the node 500 may acquire location information by way of any suitable location-determination method while remaining consistent with an example embodiment.

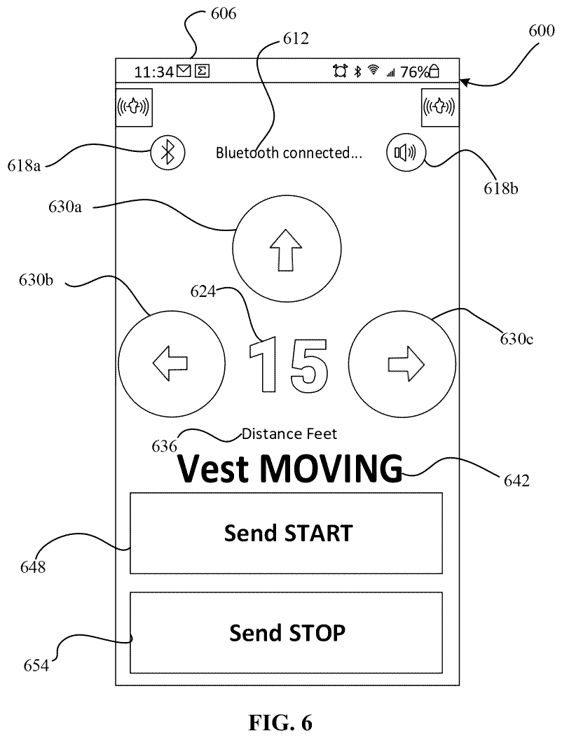

As illustrated in FIG. 5, UE 500 may also include guide assist component 517. In some examples, guide assist component 517 may be a software component. For example, guide assist component 517 may be an application on UE 500. For another example, guide assist component 517 may be a computer program product. In other examples, guide assist component 517 may be in communication with a server (e.g., server 472) that may be in communication with vest guidance unit 300. At FIG. 5, guide assist component 517 may be used to monitor vest system 200 direction and distance instructions. In this way, a guide carrying beacon 100 to monitor distance and direction instructions being provided to a sensory impaired individual wearing vest system 200. This may enable the guide to continue leading the sensory impaired individual while maintaining situational awareness on the instructions being provided without turning around to check on the sensory impaired individual. At FIG. 5, UE 500 may utilize network 455 to monitor vest guidance unit 300. UE 500 may receive telemetry data from vest guidance unit 300 via transmit/receive element 506. At FIG. 5, guide assist component 517 may translate the received telemetry data to distance and direction instructions for display. At FIG. 5, UE 500 may utilize display/touchpad/user interface 512 to display a user interface (e.g., guide assist user interface 600 from FIG. 6) that may display the distance and direction instructions. Guide assist component 517 may further provide alerts to the guide about communication failures with vest guidance unit 300.

FIG. 6 is an example user interface for an application or computer program product that may enable a guide to monitor a vest guidance unit of an impaired individual. At FIG. 6, UE 500 may utilize display/touchpad/user interface 512 to display guide assist user interface 600. As illustrated in FIG. 6, guide assist user interface 600 may include indicator(s) 606. In some examples, indicator(s) 606 may include one or more notifications to a user of UE 500 about the status of UE 500. For example, indicator(s) 606 may include a cellular reception indicator, a battery charge indication, a Bluetooth connection indicator, and/or alarm setting. In some examples, indicator(s) 606 may include communication notifications. For example, indicator(s) 606 may include text message and/or email notifications. As illustrated in FIG. 6, guide assist user interface 600 may further include user interface element 612, user interface element 618a, 618b, distance indication 624, instruction element 630a-630c, distance indication 636, status indication 642, user interface element 648, and user interface element 654. It should be recognized that guide assist user interface 600 may include more or less user interface elements. In some examples, guide assist user interface 600 may include one or more channel selection buttons. In this way, multiple vests, beacons, and/or vest guidance units may be used in the same physical area without cross interference.

At FIG. 6, user interface element 612 may include an indication of a status of connection between UE 500 and vest guidance unit 300. For example, user interface element 612 may indicate that UE 500 (and guide assist component 517) may have a Bluetooth connection to vest guidance unit 300. At FIG. 6, user interface element 618a and 618b may include connection indications or UE 500 status indications. For example, user interface element 618a may include a Bluetooth symbol to indicate that UE 500 is connected via Bluetooth to vest guidance unit 300. For another example, user interface element 618b may include a volume indicator. In some examples, user interface element 618a and 618b may be virtual buttons that may be selectable to adjust a setting for the system for which the button provides the indication. For example, user interface element 618a may be selectable in order to activate or deactivate Bluetooth on UE 500. For another example, user interface element 618a may be selectable to open a menu on which to select a device to pair UE 500 with. For yet another example, user interface element 618b may be selectable, enabling a user to adjust a volume setting on UE 500. At FIG. 6, distance indication 624 may include a numerical display of a distance from vest guidance unit 300 to beacon 100. The units of measurement for distance indication 624 may be provided in distance indication 636. In some examples, the units of measurement in distance indication 636 may be adjustable. For example, distance indication 636 may be a button. In response to detecting an input on distance indication 636, UE 500 may toggle between units of measurement (e.g., feet or meters). In this example, distance indication 624 may update automatically when a different unit of measurement is selected. At FIG. 6, distance indication 624 and 636 may enable the guide to maintain awareness of the distance from the guide to the user of vest system 200.

At FIG. 6, instruction element 630a-630c may include arrows that may indicate the direction guidance being provided to the user of vest system 200. In some examples, instruction 630a-630c may be illuminated to display the direction being provided to the user of vest system 200. For example, instruction 630c may be illuminated green to indicate that the user of vest system 200 is being given a right turn instruction as guidance. In this way, the guide may monitor guide assist user interface 600 to maintain awareness of the directions being provided to the user of vest system 200. At FIG. 6, status indicator 642 may display a status of the movement of vest system 200. For example, status indicator 642 may indicate that vest system 200 is moving (e.g., by displaying “vest moving”). For another example, status indicator 642 may indicate that vest system 200 is stationary. At FIG. 6, user interface element 648 and user interface element 654 may include buttons that may be used by UE 500 to detect an input from the guide. In response to detecting an input to user interface element 648 or user interface element 654, UE 500 may send an instruction to the user of vest system 200 via vest guidance unit 300. For example, in response to detecting an input directed to user interface element 648, UE 500 may send an instruction via guide assist component 517 to vest guidance unit 300 for the user of vest system 200 to start moving. In response to receiving the instruction, vest guidance unit 300 may use audio device 320 to provide audio instructions to the user of vest system 200 to start moving. For another example, in response to detecting an input directed to user interface element 654, UE 500 may send an instruction via guide assist component 517 to vest guidance unit 300 for the user of vest system 200 to stop moving. At FIG. 6, guide assist user interface 600 may further include alerts about communication failures between UE 500 and vest guidance unit 300.

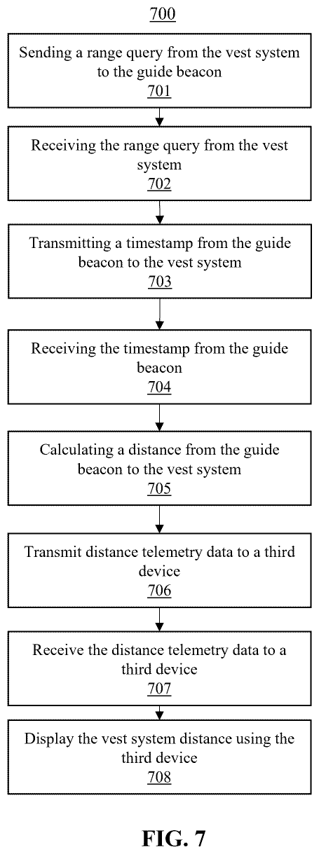

At FIGS. 7-12, reference to vest system 200 may include a description of or reference to vest guidance unit 300 as a part of vest system 200. References to a guide may include a description of or reference to beacon 100 being carried or worn by a guide to provide guidance to an impaired individual wearing vest system 200. FIG. 7 illustrates an example method 700 for providing distance guidance to a vision impaired individual in accordance with an example of the present disclosure. At step 701, vest guidance unit 300 may send a range query to beacon 100. In some examples, the range query may be sent using ultra-wideband technology. At step 702, beacon 100 may receive the range request. At step 703, beacon 100 may transmit a timestamp to vest guidance unit 300. In some examples, beacon 100 may transmit the timestamp using ultra-wideband technology. At step 704, vest guidance unit 300 may receive the timestamp from beacon 100. At step 705, vest guidance unit 300 may calculate a distance from vest guidance unit 300 to beacon 100. In some examples, the distance may be calculated based on a difference between (1) the timestamp transmitted by beacon 100 and (2) the time vest guidance unit 300 received the timestamp. At step 706, vest guidance unit 300 may transmit distance telemetry data to UE 500. In some examples, the vest guidance unit 300 may transmit the distance telemetry data via Bluetooth. At step 707, UE 500 may receive the distance telemetry data from vest guidance unit 300. At step 708, UE 500 may display, via display/touchpad/user interface 512, the distance (e.g., distance indication 624) from vest system 200 to beacon 100.

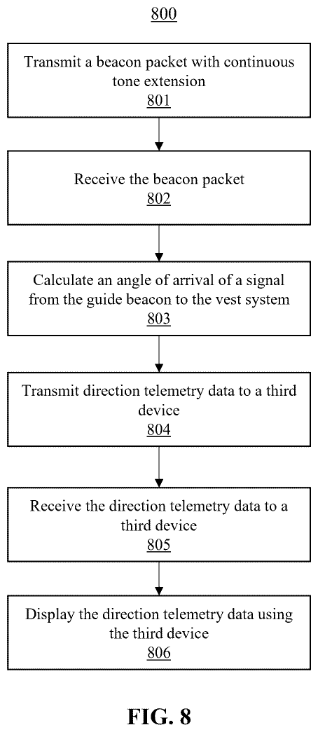

FIG. 8 illustrates an example method 800 for providing direction guidance to a vision impaired individual in accordance with an example of the present disclosure. At step 801, beacon 100 may transmit a beacon packet to vest guidance unit 300. In some examples, the beacon packet may include a continuous tone extension. At step 802, vest guidance unit 300 may receive, via antenna 354a-354c, the beacon packet. At step 803, vest guidance unit 300 may calculate an angle of arrival of the beacon packet from beacon 100. At step 804, vest guidance unit 300 may transmit direction telemetry data to UE 500. In some examples, vest guidance unit 300 may transmit the direction telemetry data via Bluetooth. At step 805, UE 500 may receive the direction telemetry data. At step 806, UE 500 may display, via display/touchpad/user interface 512 the direction from vest system 200 to beacon 100.

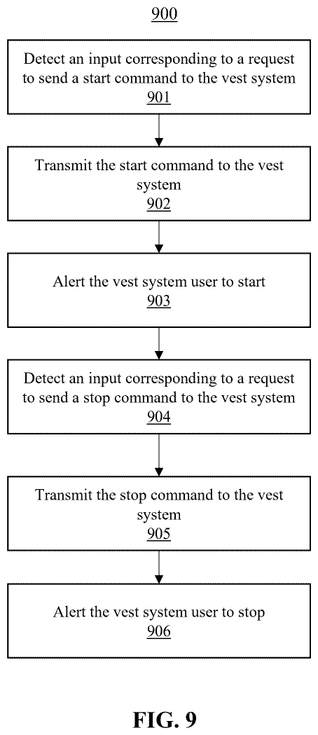

FIG. 9 illustrates an example method 900 for providing one or more directions to a vision impaired individual using a guide vest in accordance with an example of the present disclosure. At step 901, UE 500 may detect an input corresponding to a request to send a start command to vest system 200. In some examples, UE 500 may detect the input via display/touchpad/user interface 512. For example, UE 500 may detect an input directed at user interface element 648, which may be included in user interface 600, corresponding to a request to send a start command to vest system 200. At step 902, UE 500 may transmit the start command to vest system 200. Vest system 200 may receive the start command via vest guidance unit 300. At step 903, vest system 200 may alert the user of vest system 200 to start. In some examples, the start command may alert the user of vest system 200 start an exercise to follow a guide carrying beacon 100. In some examples, vest system 200 may alert the user of vest system 200 using vest guidance unit 300, which may utilize audio device 320 to provide an audio alert, corresponding to a command to start, to the user of vest system 200. In some examples, vest system 200 may utilize guidance component 224a-224e to vibrate at a first programmed frequency corresponding to a command for the user of vest system 200 to start. At step 904, UE 500 may detect an input corresponding to a request to send a stop command to vest system 200. In some examples, UE 500 may detect the input via display/touchpad/user interface 512. For example, UE 500 may detect an input directed at user interface element 654, which may be included in user interface 600, corresponding to a request to send a stop command to vest system 200. At step 905, UE 500 may transmit the stop command to vest system 200. Vest system 200 may receive the stop command via vest guidance unit 300. At step 906, vest system 200 may alert the user of vest system 200 to stop. The command to stop may be used to alert the user of vest system 200 to terminate an exercise in place. For example, if the user of vest system 200 is following a guide carrying beacon 100 on a walk, the command to stop may be used to alert the user of vest system 200 to stop walking. In some examples, vest system 200 may alert the user of vest system 200 using vest guidance unit 300, which may utilize audio device 320 to provide an audio alert, corresponding to a command to stop, to the user of vest system 200. In some examples, vest system 200 may utilize guidance component 224a-224e to vibrate at a second programmed frequency corresponding to a command to stop.

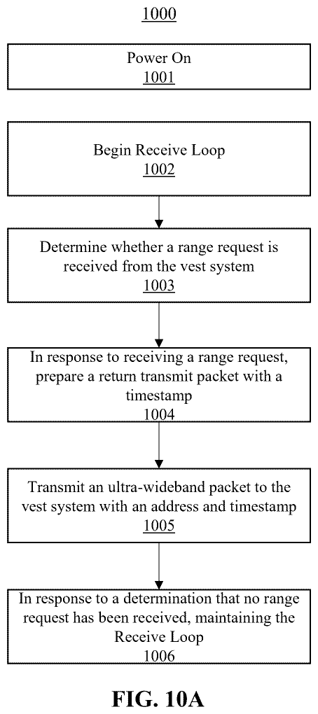

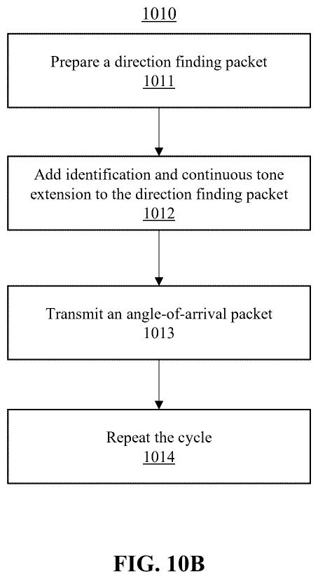

FIG. 10A illustrates an example process 1000 for transmitting a ranging signal to a vest system of an impaired individual using a guide beacon in accordance with an example of the present disclosure. At step 1001, beacon 100 may power on. At step 1002, beacon 100 may begin a receive loop. In some examples, while beacon 100 is in a receive loop, beacon 100 may be configured to receive one or more signals from vest system 200. At step 1003, beacon 100 may determine whether a range request has been received from vest system 200. In some examples, beacon 100 may receive a range query from vest guidance unit 300. At step 1004, in response to receiving the range request, beacon 100 may prepare a return transmit packet. In some examples the return packet may include a timestamp. At step 1005, beacon 100 may transmit an ultra-wideband packet to vest system 200. In some examples, the packet may include an address and timestamp. In that way, vest system 200 may identify the origin of the packet and make a determination of the distance from vest system 200 to beacon 100 (e.g., the guide). At step 1006, in response to a determination that no range request has been received, beacon 100 may maintain the receive loop. In that way, beacon 100 may be ready to receive a range query from vest system 200 at any time while the receive loop is maintained.

FIG. 10B illustrates an example process 1010 for transmitting a direction-finding signal to a vest system of an impaired individual using a guide beacon in accordance with an example of the present disclosure. At FIG. 10B, steps 1011-1014 may take place after step 1001 from FIG. 10A. At step 1011, the beacon may prepare a direction-finding packet. In some examples, the direction-finding packet may utilize Bluetooth technology. At step 1012, the beacon may add an identification and continuous tone to the direction-finding packet. At step 1013, beacon 100 may transmit an angle-of-arrival packet to vest system 200. In some examples, the angle-of-arrival packet may include the direction-finding packet. In some examples, the direction-finding packet may be transmitted using a Bluetooth signal. In some examples, beacon 100 may transmit the direction-finding packet over a pre-programmed interval of time. For example, beacon 100 may transmit the direction-finding packet over an interval of 47 milliseconds. At step 1014, beacon 100 may repeat the cycle of step 1011-1013.

FIG. 11A illustrates an example process 1100 for initializing a vest guidance unit in accordance with an example of the present disclosure. In this example, process 1100 may be described from the perspective of vest guidance unit 300. At step 1101, vest guidance unit 300 may power on. At step 1102, vest guidance unit 300 may initiate a setup. In some examples, the setup may include initializing one or more modules, variables, and/or objects included in vest guidance unit 300. At step 1103, vest guidance unit 300 may establish a configuration based on one or more settings of switch 366. The operations for configuring the one or more settings of switch 366 may further be discussed in FIG. 11C. At step 1104, vest guidance unit 300 may establish an operation mode configuration based on saved erasable programmable read-only memory (EPROM) settings from the last mode used. At step 1105, vest guidance unit 300 may perform a self-test of system audio and/or one or more direction channels.

FIG. 11B illustrates an example process for providing guidance to a vision impaired individual in accordance with an example of the present disclosure. At step 1110, vest guidance unit 300 may utilize antenna 354a-354c to detect an incoming angle of arrival beacon packet (e.g., a direction-finding packet transmitted by beacon 100 at step 1013 from FIG. 10B). At step 1111, vest guidance unit 300 may read the angle of arrival beacon packet. At step 1112, vest guidance unit 300 may extract an azimuth from the beacon packet. The azimuth may indicate a direction from vest system 200 to beacon 100. At step 1113, vest guidance unit 300 may filter one or more received azimuths from the beacon packet. In this way, vest guidance unit 300 may filter out inaccurate signals to determine an accurate direction from vest system 200 to beacon 100. At step 1114, vest guidance unit 300 may send range query to beacon 100 via an ultra-wideband module. At step 1115, in accordance with a determination that the ultra-wideband range is valid, vest guidance unit 300 may translate an azimuth to a direction channel. In some examples, the ultra-wideband range may not be valid. In these examples, vest guidance unit 300 may extract and calculate a range based on an RSSI. For example, vest guidance unit 300 may determine the range based on the strength of a radio signal received from beacon 100. At step 1116, based on the determined range, vest guidance unit 300 may create a beacon pulse interval. In some examples, vest system 200 may vibrate guidance component 224a-224e at a frequency corresponding to the determined beacon pulse interval. In some examples, vest guidance unit 300 may illuminate indicator 328a-328e in a frequency corresponding to the determined beacon pulse interval. At step 1117, vest guidance unit 300 may calculate the direction indicators based on the received azimuths. In some examples, vest guidance unit 300 may cause indicator 328a-328e to illuminate based on a selected mode and the azimuth. For example, vest guidance unit 300 may cause indicator 328a and 328b to illuminate to indicate that the azimuth from vest system 200 to the guide is to the right of the user of vest system 200.

At step 1118, vest guidance unit 300 may determine motion of vest system 200. In some examples, the motion may be detected using sensor 384. For example, sensor 384 may be an accelerometer that may determine the motion of vest system 200. At step 1119, vest guidance unit 300 may transmit telemetry and move/stop data to UE 500. In some examples, UE 500 may display the telemetry and/or move/stop data via guide assist user interface 600. The telemetry data may include the determined azimuth, range, and/or speed of vest system 200. The move/stop data may include one or more indications of whether vest system 200 is moving or stopped. At step 1120, vest guidance unit 300 may update display 378.

FIG. 11C illustrates a process for setting one or more modes for a guidance vest system in accordance with an example of the present disclosure. At step 1130, vest guidance unit 300 may detect an input corresponding to a request to change a mode of vest system 200. Vest guidance unit 300 may detect the input via switch 366. In some examples, switch 366 may include one or more switches. For example, switch 366 may include four switches. In that example, an input directed to a first switch of switch 366 may correspond to a request to change a pulse setting of vest system 200. An input directed to a second switch of switch 366 may correspond to a request to change Wi-Fi and/or Bluetooth filter setting of vest guidance unit 300. An input directed to the third switch of switch 366 may correspond to a request to configure an ultra-wideband and/or phased array antenna module. An input directed to a fourth switch of switch 366 may correspond to enabling or disabling the ability of vest guidance unit to share telemetry data to UE 500. It should be recognized that switch 366 may include the four modes in more or less switches than four. For example, switch 366 may include one switch that may be configured to detect one or more inputs corresponding to a request to change one of the four modes. At step 1131, vest guidance unit 300, using a combination of (1) a speech synthesizer and (2) speech recognition, may prompt and enable a user of vest system 200 to select one or more operation modes and/or change settings. At step 1132, in response to detecting an input corresponding to a request to change the mode of vest system 200, vest guidance unit 300 may set the mode. For example, in response to detecting an input to switch 366 corresponding to a request to disable sharing of telemetry data with UE 500, vest guidance unit 300 may disable and/or stop sharing telemetry data with UE 500.

FIG. 11D illustrates an example process for setting one or more operating modes of a guide vest in accordance with an example of the present disclosure. In some examples, the one or more operating modes may control when verbal speech announcements, tones, warnings, and/or distance alerts may occur. At step 1140, vest guidance unit 300 may detect a respective input to button 318 corresponding to a request to change one or more modes of vest system 200. At step 1141, in accordance with a determination that the input is a first input, vest guidance unit 300 may set a squawk mode. In some examples, the first input may toggle between one or more settings of the squawk mode. A squawk mode, when activated, may include one or more verbal announcements, via audio device 320, to guide an individual wearing vest system 200. For example, when centered on a guide, with squawk mode activated, vest guidance unit 300 may announce a distance from vest system 200 to the guide. For another example, when off center of the guide with squawk mode activated, vest guidance unit 300 may announce one or more directions for the user of vest system 200 to turn while pulsing guidance component 224a-224e. At step 1142, in accordance with a determination that the respective input is a second input, vest guidance unit 300 may set a tone mode. In some examples, the tone mode, when activated may cause vest guidance unit 300 to pulse an audible tone, via audio device 320, when vest system 200 is centered on the guide. In some examples, if vest system 200 is off-center from the guide, vest guidance unit 300 may emit no tone. In these examples, vest system 200 may vibrate guidance component 224a-224e to indicate a direction to turn. At step 1143, in accordance with a determination that the respective input is a third input, vest guidance unit 300 may set a glide mode. In some examples, the glide mode may enable the user of vest system 200 to maintain a distance from guide plus or minus a buffer. In these examples, vest system 200 may vibrate if centered in the glide area. In some examples, if vest system 200 draws closer to the guide than the glide area, vest guidance unit 300 may utilize audio device 320 to emit a tone. In some examples, if vest system 200 drifts back to a further distance than the glide area, vest guidance unit 300 may utilize audio component 320 to emit a tone. For example, drawing too close to the guide may cause vest guidance unit 300 to emit a high-pitch tone and drifting too far away from the guide may cause vest guidance unit 300 to emit a low-pitch tone. In some examples, throughout all settings, guidance component 224a-224e may increase the pulse tempo as vest system 200 draws closer to the guide and decrease the pulse tempo as vest system 200 drifts away from the guide. At step 1144, in accordance with a determination that the respective input is a fourth input, vest guidance unit 300 may set a speed mode (e.g., slow or fast), which may aid in using vest system 200 for relatively slower or faster sports. At step 1145, in accordance with a determination that the respective input is a fifth input, vest guidance unit 300 may set a boost mode (e.g., on or off) to allow lower intensity vibration pulses. At step 1146, in accordance with a determination that the respective input is a sixth input, vest guidance unit 300 may set an idle mode to enable vest system 200 to remain powered on and communicating with beacon 100 with no pulsing. At step 1147, vest guidance unit 300 may apply the changes of the one or more modes to vest system 200.

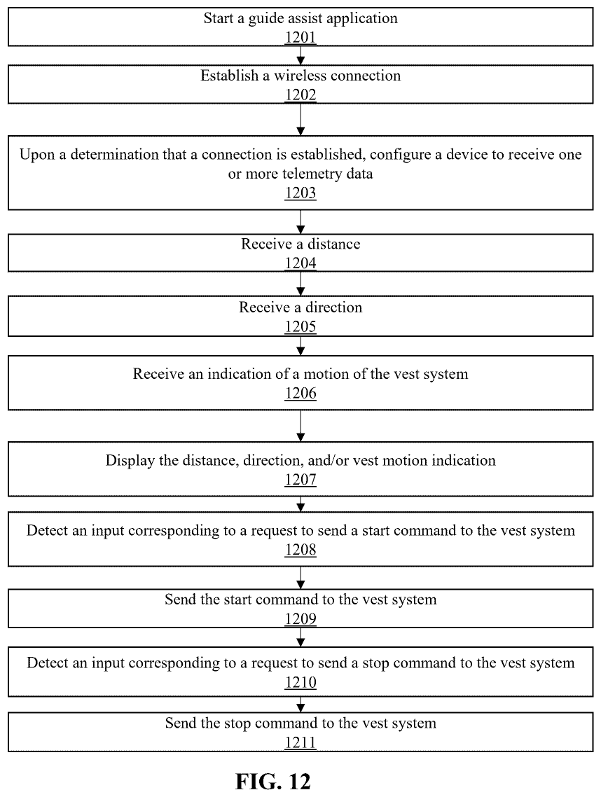

FIG. 12 illustrates an example method for utilizing a guide assist application to enable a guide to maintain situational awareness on an individual using vest system 200 in accordance with an example of the present disclosure. At step 1201, a guide may utilize UE 500 to initiate a guide assist application. At step 1202, UE 500 may utilize the guide assist application to establish a wireless connection with vest system 200. At step 1203, in accordance with a determination that a connection to vest system 200 is established, UE 500 may be configured, using the guide assist application, to receive one or more telemetry data from vest system 200. In some examples, in accordance with a determination that a connection to vest system 200 is not established, UE 500 may display, via display/touchpad/user interface 512, an indication that no connection is established. For example, UE 500 may display “Bluetooth connection lost” on guide assist user interface 600. At step 1204, UE 500 may utilize the guide assist application to receive a distance from vest system 200. The distance may be a range from the guide to vest system 200. At step 1205, UE 500 may utilize the guide assist application to receive a direction from vest system 200. The direction may be the direction (e.g., azimuth) from vest system 200 to the guide. At step 1206, UE 500 may receive an indication motion of vest system 200. At step 1207, UE 500 may utilize display/touchpad/user interface 512 to display guide assist user interface 600 including a user interface element corresponding to the distance, a user interface element corresponding to the direction, and/or an indication of the motion of vest system 200 (e.g., vest moving or vest stopped). At step 1208, UE 500 may detect an input corresponding to a request to send a start command to vest system 200. In some examples, the input corresponding to the request to send the start command may be directed to a user interface element corresponding to a start command on guide assist user interface 600. At step 1209, UE 500 may send the start command to vest system 200. At step 1210, UE 500 may detect an input corresponding to a request to send a stop command to vest system 200. In some examples, the input corresponding to the request to send the stop command may be directed to a user interface element corresponding to a stop command on guide assist user interface 600. At step 1211, UE 500 may send the stop command to vest system 200.

It may be helpful in certain applications to allow the guide to provide manual, explicit instructions to vision impaired individual. In some examples, a method for the guide to send instructions to the blind athlete vest can use a thumb switch mounted, worn, or carried. In some examples, the thumb switch may be a 5-way thumb switch or include other inputs. In some examples, the thumb switch (and, in some examples, other hardware operatively coupled therewith) can be mounted on a kayak paddle or other piece of equipment used by the guide. In alternative embodiments, the thumb switch (and, in some examples, other hardware operatively coupled therewith) can be mounted to another piece of equipment, worn on the arm or wrist, mounted to a vehicle or seat, integrated into a vest, et cetera, and may be distributed to multiple positions (e.g., thumb switch is a remote for a device worn on guide's back, carried in guide's pocket, kept in guide's pack, et cetera). The thumb switch (e.g., button 318) may be cabled to a small transmitter (e.g., vest guidance unit 300) housed in a waterproof box or other housing. In the example shown in FIGS. 3A-3C, the transmitter box is clamped to the center of the guide paddle. Such embodiments are effective for the guide to send navigation instructions from his paddle thumb switch to the vest. Such embodiments may be more suited to the guide traveling behind the blind kayaker (as opposed to leading from ahead) in order to visually observe and correct direction disabling the guides ability to recognize approaching hazards. During some activities like kayaking, it may also be cumbersome for the guide to control their own kayak while using the thumb switch. As such, other implementations may benefit sports such as kayaking or skiing.

To provide an example of enabling the guide to lead and use handheld equipment, an example method of guidance for a vision impaired individual may include using GPS receivers on both the guide as well as the blind athlete vest (e.g., beacon 100 and vest system 200 may include GPS receivers). Current GPS coordinates of the guide can be transmitted in a radio stream to the blind athlete vest where current guide coordinates can be compared with the current vest GPS coordinates. A microcontroller in the vest can use algorithms to calculate azimuth, distance, and speed to the guide. This worked for long ranges but may not be appropriate in applications benefitting from location “resolution” above standard GPS resolution (e.g., 2-to-10-meter accuracy). Other techniques can be used for guiding a vision impaired individual with the precision needed while in close proximity. Current GPS RTK technology has high accuracy but requires use of a fixed base station or availability of an RTK connection service requiring a WIFI or cellular connection to the internet, which may not be possible in remote locations. Where appropriate, embodiments herein may use GPS, and where available, higher-accuracy GPS signaling can be used. It should be recognized that a method for guidance of the vision impaired individual may use a combination of one or more guidance techniques disclosed herein.

Systems and methods herein may employ Bluetooth Direction Finding and/or associated Real-Time Location Systems (RTLS). Bluetooth may be a flexible option for accuracy and responsiveness within the ranges and operating conditions of many use cases. The guide's device may transmit an AOA (angle of arrival) Bluetooth 5.1 beacon with Continuous Tone Extension to broadcast its location to the vision impaired individual's unit. In some examples, the AOA Bluetooth 5.1 beacon can be broadcast at an interval of 66 milliseconds (about 15 times per second), preventing outputs from lagging behind rapidly changing conditions. The AOA Bluetooth 5.1 beacon can be housed in a ruggedized housing, such as a shock and water-resistant polycarbonate case (e.g., beacon 100). The vision impaired individual's unit can be similarly housed.

Different example aspects may favor certain techniques based on cost, size and weight of hardware, power requirements, range, and other parameters. Options other than manual and GPS include one or more of the techniques discussed below.

2-way radio headset guidance: Another form of audio guidance may include two-way radio headset guidance. This guidance technique may require continuous reliance on hearing (e.g., for the vision impaired individual) as well as continuous voice instruction (e.g., for the guide).

Sonar/ultrasonic: Guidance from vest system 200 to the guide may use sonar or ultrasonic technology. A guidance technique that includes the use of sonar or ultrasonic technology may be short range and may be degraded over water due to reflection from water surface and ripple. Sonar also lacks a reference point for sound travel time, which may reduce the accuracy of the guide's calculated range and speed. Sonar is also generally directional, and thus may have higher utility (e.g., to determine whether a guide moved right or left) in multiple-transducer or redirectable-transducer arrangements.

InfraRed (modulated IR); Guidance from vest system 200 to the guide may include the use of one or more infrared sensors. This guidance technique may be degraded in sunlight without high power modulated to IR light-emitting diodes. Such a system may have significant power requirements to extend the range beyond several meters, increasing the size and weight of the system and batteries. IR is also single directional and may be challenging to employ on moving surfaces.

RF Tag/Radio Direction Finding: Guidance from the user of vest system 200 to the guide may utilize one or more RF tags and/or radio direction finding. RF tags or radio direction finding may have a larger form factor and be more useful when multiple points are provided to triangulate a bearing. This technique can have sensitivity, selectivity, and directional issues over water without use of a large directional antenna and multiple points to triangulate a bearing.

Laser/light beam range finder: Lasers and light beams may be used to provide guidance for a vision impaired user of vest system 200. This technique may involve safety and detectability issues, given the high-energy, narrow, single-directional beam. Use of these techniques can be further degraded from unstable platforms, such as a boat or individual prone to tilt and pitch.

Camera/object identification: Cameras and similar machine vision techniques may be used to provide guidance for a vision impaired individual. These require a live video stream with object recognition/detection software. In some examples, vest system 200 may include one or more cameras or sensors that may provide this capability. Computing power, battery life, the impacts from changes in lighting, and electronic and software complexity can be factors in such embodiments.

LIDAR: In some examples, vest system 200 may use LIDAR in a scanning mode to provide guidance for a vision impaired individual, although it is impractical for many use cases.

Ultrawide Band (UWB); In these embodiments a radio beacon (e.g., guide device; beacon 100) can be used with a blind athlete vest outfitted with spaced-apart UWB antennas (e.g., two antennae spaced 18 inches, other arrangements) to compare distances and angles. While functional in certain embodiments, the resolution and range may be limited for many applications and the mounting of appropriate antennae on the vision impaired individual may be impractical for many applications.

WiFi: In some examples, WiFi signals can be emitted and tracked by a receiver contained in vest system 200 according to their strength and other characteristics. WiFi can be used alone or to carry information over a wireless network in conjunction with other “follow me” signals in various embodiments.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. An apparatus, comprising:
a guide unit configured to be worn or carried by a guide and configured to emit a guide signal;
a participant unit configured to be worn by a participant, the participant unit configured to receive the guide signal from the guide unit and interpret the guide signal to determine a direction and a distance from the participant unit to the guide unit; and
a group of haptic output components configured to be worn by the participant, the haptic output components arranged in a manner such that they are distributed around the participant when worn,
wherein the participant unit is configured to generate, based on the direction and the distance, an output signal,
wherein the participant unit configured to send the output signal to the group of haptic components,
wherein one of the group of haptic components most closely corresponds to the direction,
wherein the one of the group of haptic components is configured to actuate in response to the output signal based on the direction, and
wherein actuation of the one of the group of haptic components is configured to represent the distance.

2. The apparatus of claim 1, wherein the guide signal utilizes Bluetooth direction finding.

3. The apparatus of claim 1, wherein each of the group of haptic components is water resistant.

4. The apparatus of claim 1, wherein the participant unit includes a phased-array antenna.

5. The apparatus of claim 1, comprising:
a second guide unit configured to provide, at the guide, status information about the participant unit.

6. The apparatus of claim 1, wherein the guide unit is configured to provide, at the guide, status information about the participant unit.

7. A method comprising:
sending, from a first device, a request for a ranging signal to a second device different from the first device;
in response to receiving the request, sending, from the second device, the ranging signal to the first device;
in response to receiving the ranging signal to the second device and in accordance with a determination of a range from the first device to the second device, providing a notification corresponding to the range from the first device to the second device, via the first device, to a user of the first device;
while providing the notification corresponding to the range from the first device to the second device, sending a signal corresponding to an angle of arrival from the second device to the first device; and
in response to receiving the signal corresponding to an angle of arrival and in accordance with a determination of a direction from the first device to the second device, providing a notification corresponding to a direction from the first device to the second device, via the first device, to the user of the first device.

8. The method of claim 7, comprising:
sending, to the first device from a third device, a signal corresponding to a respective command, wherein the third device is different from the first device and the second device;
receiving, to the first device, the signal corresponding to a respective command from the third device;
in response to receiving the signal corresponding to the respective command from the third device;
in accordance with a determination that the respective command is a first command, providing a start command, via the first device, to a user of the first device; and
in accordance with a determination that the respective command is a second command, providing a stop command, via the first device, to the user of the first device.

9. The method of claim 7, wherein the ranging signal uses a short-range point-to-point communication technique.

10. The method of claim 7, wherein the notification is provided by haptic feedback.

11. The method of claim 10, wherein the haptic feedback is provide by a waterproof component.

12. The method of claim 7, comprising:
sending from the first device to the second device a status signal indicating a status of the first device to the second device.

13. The method of claim 7, wherein the notification is provided by a visual signal.

14. The method of claim 7, wherein the notification is provided by an audible signal.

15. A method comprising:
at a first device that is in communication with one or more display generation components and a second device different from the first device:
displaying, via the one or more display generation components, a user interface including an indication of a respective distance from the second device to a third device, an indication of a respective direction from the second device to the third device, and an indication of a respective state of motion of the second device, wherein the third device is different from the first device and the second device;
while displaying the user interface:
receiving from the second device a signal corresponding to the respective distance from the second device to the third device;
in response to receiving the signal corresponding to the respective distance from the second device to the third device:
in accordance with a determination that the respective distance is a first distance, displaying, via the one or more display generation components, the user interface wherein the indication of the respective distance from the second device to the third device is an indication of the first distance from the second device to the third device; and
in accordance with a determination that the respective distance is a second distance different from the first distance, displaying, via the one or more display generation components, the user interface, wherein the indication of the respective distance from the second device to the third device is an indication of the second distance from the second device to the third device;
receiving from second device a signal corresponding to the respective direction from the second device to the third device;
in response to receiving the signal corresponding to the respective direction from the second device to the third device:
in accordance with a determination that the respective direction is a first direction, displaying the user interface wherein the indication of the respective direction from the second device to the third device is an indication of a first direction from the second device to the third device; and
in accordance with a determination that the respective direction is a second direction different from the first direction, displaying, via the one or more display generation components, the user interface wherein the indication of the respective direction from the second device to the third device is an indication of the second direction from the second device to the third device;
receiving, from the second device, a signal corresponding to the respective state of motion of the second device;
in response to receiving the signal corresponding to the respective state of motion of the second device:
in accordance with a determination that the respective state of motion is a first state of motion, displaying, via the one or more display generation components, the user interface, wherein the indication of the respective state of motion is an indication of the first state of motion; and
in accordance with a determination that the respective state of motion is a second state of motion, displaying, via the one or more display generation components, the user interface, wherein the indication of the respective state of motion is an indication of the second state of motion.

16. The method of claim 15, wherein the first device is in communication with one or more input devices, the method further comprising:
while displaying the user interface, displaying, via the one or more display generation components, a first button and a second button different from the first button;
detecting, via the one or more input devices, an input corresponding to a respective button;
in response to detecting the input corresponding to the respective button:
in accordance with a determination that the respective button is the first button, displaying, via the one or more display generation components, an indication that a start command has been sent to the second device; and
in accordance with a determination that the respective button is the second button, displaying, via the one or more display generation components, an indication that a stop command has been sent to the second device.

17. The method of claim 15, wherein the signal uses a short-range point-to-point communication technique.

18. The method of claim 15, wherein the direction or distance is indicated by haptic feedback.

19. The method of claim 18, wherein the haptic feedback is provide by a waterproof component.

20. The method of claim 15, comprising:
sending from the first device to the second device a status signal indicating a status of the first device to the second device.
